(19) United States
(12) Patent Application Publication
(10) Pub. No.: US 2011/0101214 A1
(43) Pub. Date: May 5, 2011

(54) COUPLING DIFFERENTIAL MOBILITY BASED AMBIENT PRESSURE ION PREFILTERING AND ION FOCUSING AT LOW FLOW RATES FOR A PORTABLE MASS SPECTROMETER

(76) Inventors: Raanan A. Miller, Chestnut Hill, MA (US); Erkinjon G. Nazarov, Lexington, MA (US); C. James Morris, Norfolk, MA (US); Stephen Coy, Wayland, MA (US); Evgeny Krylov, Franklin, MA (US); D. Westervelt Davis, Wellesley, MA (US)

(21) Appl. No.: 12/856,366

(22) Filed: Aug. 13, 2010

Related U.S. Application Data
(60) Provisional application No. 61/233,565, filed on Aug. 13, 2009.

(51) Int. Cl. H01J 49/30; H01J 49/00

(52) U.S. Cl. 250/282; 250/298

(57) ABSTRACT

A sample analysis apparatus and system including an ion inlet, an ion detector and an ion focusing assembly for converging a plurality of ion streams from the ion inlet into at least one focused ion stream.

### REFERENCE TO RELATED APPLICATIONS

This application claims the benefit of U.S. Application No. 61/233,565, filed on Aug. 13, 2009, and entitled “Coupling Differential Mobility Based Ambient Pressure Ion Prefiltering and Ion Focusing At Low Flow Rate for a Portable API Mass Spectrometer”, the contents of which are incorporated herein in their entirety.

### FIELD

Applicants' teachings relate to ion mobility spectrometry for sample preparation, filtering, and detection in an ion mobility spectrometer.

### BACKGROUND

At high electric fields, ion mobility becomes dependent upon the applied electric field strength and the ion drift velocity may no longer behave linearly with field strength. The field asymmetric waveform ion mobility spectrometer (FAIMS, also known as RF-IMS) utilizes these significantly higher electric fields, and identifies the ion species based on the difference in its mobility in high and low strength electric fields.

The FAIMS spectrometer uses an ionization source, such as an ultra violet photo-ionization lamp, to convert a gas sample into a mixture of ion species with each ion type corresponding to a particular chemical in the gas sample. The ion species are then passed through an ion filter where particular electric fields are applied between electrodes to select an ion type allowed to pass through the filter. Once through the filter the ion type hits a detector electrode and produces an electrical signal. To detect a mixture of ion species in the sample, the electric fields applied between the filter electrodes can be scanned over a range and a spectrum generated. The ion filtering is achieved through the combination of two electric fields generated between the ion filter electrodes, an asymmetric, periodic, radio frequency (RF) electric field, and a dc compensation electric field. The asymmetric RF field has a significant difference between its peak positive field strength and negative field strength. The asymmetric RF field scatters the ions and causes them to deflect to the ion filter electrodes where they are neutralized, while the compensation field prevents the scattering of a particular ion allowing it to pass through to the detector. The ions are filtered in instruments on the basis of the difference in the mobility of the ion at high electric fields relative to its mobility at low electric fields. That is, the ions are separated due to the compound dependent behavior of their mobility at high electric fields relative to their mobility at low electric fields.

The FAIMS approach is based on an observation of Mason and McDaniel [.W. McDaniel and Edward A. Mason, The mobility and diffusion of ions in gases, John Wiley & Sons, 1973] who found that the mobility of an ion is affected by the applied electric field strength. Above an electric field to gas density ratio (E/N) of 40 Td (E>10,700V/cm at atmospheric pressure) the mobility coefficient K(E) has a non-linear dependence on the field. This dependence is believed to be specific for each ion species. Below are some examples from Mason and McDaniel [.W. McDaniel and Edward A. Mason, The mobility and diffusion of ions in gases, John Wiley & Sons, 1973]. The mobility for the cluster ion CO⁺CO increases with increasing field strength (FIG. 7-1-K-1 in reference [.W. McDaniel and Edward A. Mason, The mobility and diffusion of ions in gases, John Wiley & Sons, 1973]). For some molecular and atomic ions the coefficient of mobility can change in a more complex way. For example, for atomic ions K⁺, the mobility coefficient in carbon monoxide gas increases with increasing field by as much as 20%, but above E/N˜200 Td the coefficient starts to decrease (FIG. 7-1-K-3 in reference [.W. McDaniel and Edward A. Mason, The mobility and diffusion of ions in gases, John Wiley & Sons, 1973]). For some other ions for example N⁺, N₃⁺ and N₄⁺ the mobility changes very little (FIG. 7-1-H-1/2 in reference [.W. McDaniel and Edward A. Mason, The mobility and diffusion of ions in gases, John Wiley & Sons, 1973]). FIG. 1A illustrates schematically three possible ion mobility dependencies on electric field. For simplicity we will assume that the low field value of the mobility K(Eₘᵢₙ) in a weak electric field (E approximately 10²-10³ V/cm) is the same for all three ion types. However, at Eₘₐₓ the value of the mobility coefficient K(Eₘₐₓ) is different for each ion type.

The field dependence of the mobility coefficient K(E) can be represented by a series expansion of even powers of E/N [18]

K(E)=K(0)[1+α₁(E/N)²+α₂(E/N)⁴+ . . . ] (1)

where K(0) is the coefficient of mobility of the ion in a weak electric field, and α₁, α₂ are coefficients of the expansion. This equation can be simplified by using an effective α(E) as shown in equation 2 [T. W. Carr, Plasma Chromatography, Plenum Press, New York and London, 1984],

K(E)≈K(0)[1+α(E)]. (2)

According to this expression when α(E)>0 the mobility coefficient K(E) increases with field strength, when α(E)˜0 the mobility K(E) does not change, and when α(E)<0 then K(E) decreases with increasing field strength. An expression for the field dependent mobility coefficient can also be derived from momentum and energy balance considerations. Where the energy of the ion ε= 3/2 kT_{eff} can be expressed as a function of its effective temperature [18-20].

$$K ( E ) = \frac{v}{E} = \frac{q}{N} {( \frac{1}{3 μ {kT}_{eff}} )}^{1 / 2} \frac{1}{Ω ( {T}_{eff} )} . \qquad ( 3 )$$

The case where α(E)<0 can be explained based on the model presented in equation 3, if one assumes the value of the ion neutral cross-section Ω(T_{eff}) does not change significantly for rigid-sphere interactions [T. W. Can, Plasma Chromatography, Plenum Press, New York and London, 1984, E. A. Mason and E. W. McDaniel, Transport Properties of Ions in Gases, Wiley, New York, 1988] and the reduced mass μ is constant. Under these conditions one finds that the mobility K(E) will decrease if the effective temperature, or energy, of the ion increases. Physically this effect has a simple explanation. When the electric field strength is increased the ions are driven harder through the neutral gas. This increases the ion neutral collision frequency, which leads to a reduced average ion velocity and a reduced ion mobility coefficient.

The rigid-sphere model however, does not explain the experimental results which show that with certain ions the mobility increases with increasing electric field (α(E)>0). One of the possible explanations for the increased mobility at elevated values of E/N is offered when one allows for ion de-clustering at high field strengths to occur. Ions in ambient conditions in a weak electric field generally do not exist in a free state. They are usually in cluster form (for example, MH⁺(H₂0)ₙ) with n polar molecules such as water attached. As the electric field strength is increased the kinetic energy and consequently the effective temperature (T_{eff}) of the ion increases due to the energy imparted between collisions. This can lead to a reduction in the level of ion clustering (reduction in n) resulting in a smaller ion cross-section Ω(T_{eff}) and a smaller reduced mass μ for the ion. According to equation 3 then, if do to de-clustering the cross-section and reduced mass decrease in a sufficient manner to offset the increase in T_{eff} the case where α(E)>0 can be explained.

The third case when α(E)˜0 can be explained by a decrease in ion cross section due to de-clustering which is offset by an increase in the effective temperature of the ion. This results in no net change to the mobility coefficient of the ion.

The mechanism of operation of the FAIMS for ion filtering is described in the following. Consider three kinds of ions with different mobility coefficient dependencies on electric field (i.e., α(E)>0, α(E)<0, α(E)˜0) which are formed, due to local ionization of neutral molecules, at the same location in a narrow gap between two electrodes, as shown on FIG. 1B. A stream of carrier gas transports these ions longitudinally down the drift tube between the gap. If an asymmetric RF electric field is then applied to the electrodes the ions will oscillate in a perpendicular direction to the carrier gas flow, in response to the RF electric field, while moving down the drift tube with the carrier gas. A simplified asymmetric RF electric field waveform (FIG. 1C) with maximum field strength |Eₘₐₓ|>10,000 V/cm and minimum field strength |Eₘᵢₙ|<<|Eₘₐₓ| is used here to illustrate the operation principle of the RF-IMS. The asymmetric RF waveform is designed such that the time average electric field is zero and

|Eₘₐₓ|t₁=|Eₘᵢₙ|t₂=β. (1)

t₁ is the portion of the period where the high field is applied and t₂ is the time the low field is applied. β is a constant corresponding to the area under-the-curve in the high field and low field portions of the period. The ion velocities in the y-direction are given by

V_{y}=K(E)E(t). (2)

Here K is the coefficient of ion mobility for the ion species and E is the electric field intensity, in this case entirely in the y-direction. If the amplitude of the positive polarity RF voltage pulse (during t₁) produces an electric field of strength greater than 10,000 V/cm then the velocity towards the top electrode

Vᵤₚ=Kᵤₚ|Eₘₐₓ| (3)

will differ for each of the ion species (FIG. 1B) since, as shown in FIG. 1A, the coefficient of mobility Kᵤₚ for each ion at the high field condition is different. The ions with α(E)>0 will move faster and ions with α(E)<0 will have the smallest velocity, therefore, the slope of each ion's trajectory will also differ. In the next portion of the period (t₂), once the polarity of the RF field has switched, all three ion types will begin moving with the same velocity

V_{down}=K(Eₘᵢₙ)|Eₘᵢₙ| (4)

down towards the bottom plate. In this low field strength condition (see FIG. 1A) all three ion types will have the same mobility coefficient K_{down}. Therefore, all three ion trajectories will have the same slope in this portion of the period (FIG. 1B).

The ion displacement from its initial position in the y-direction is the ion velocity in the y-direction V_{y} multiplied by the length of time Δt the field is applied

Δy=V_{y}Δt. (5)

In one period of the applied RF field the ion moves in both the positive and negative y-directions. By substituting equation 2 into equation 5 the average displacement of the ion over one period of the RF field can be written as

Δy_{RF}=Kᵤₚ|Eₘₐₓ|t₁−K_{down}|Eₘᵢₙ|t₂. (6)

Using equation 1 this expression can be re-written as

Δy_{RF}=β(Kᵤₚ−K_{down})=βΔK. (7)

Since β is a constant determined by the applied RF field, the y-displacement of the ion per period of the RF field T=t₁+t₂ depends on the change in mobility of the ion between its high and low field conditions. Assuming the carrier gas only transports the ion in the z-direction. The total ion displacement Y (in the y-direction) from its initial position (due to the electric field) during the ions residence time tᵣₑₛ between the ion filter plates can be expressed as

$$Y = \frac{Δ {y}_{RF}}{( {t}_{1} + {t}_{2} )} {t}_{res} = \frac{βΔ K}{T} {t}_{res} \qquad ( 8 )$$

The average ion residence time inside the ion filter region is given in equation 9. A is the cross-section area of the filter region, L is the length of the ion filter electrodes, V is the volume of the ion filter region V=AL, and Q is the volume flow rate of the carrier gas.

$${t}_{res} = \frac{AL}{Q} = \frac{V}{Q} . \qquad ( 9 )$$

Substituting equation 9 into equation 8, noting from equation 1 that β=|Eₘₐₓ|t₁ and defining the duty cycle of the RF pulses as D=t₁/T. The equation for displacement of the ion species, equation 8, can be re-written as

$$Y = \frac{Δ {KE}_{max} VD}{Q} \qquad ( 10 )$$

where Y is now the total displacement of the ion in the y-direction based on the average ion residence time in the ion filter region. From equation 10 it is evident that the vertical displacement of the ions in the gap are proportional to the difference in coefficient of mobility between the low and high field strength conditions. Different species of ions with different ΔK values will displace to different values of Y for a given tᵣₑₛ. All the other parameters including the value of the maximum electric field, the volume of the ion filter region, the duty cycle and the flow rate, to first order are essentially the same for all ion species.

When a low strength DC field (|E_{c}|<|Eₘᵢₙ|<<|Eₘₐₓ|) is applied in addition to the RF field, in a direction opposite to the average RF-induced (y-directed) motion of the ion, the trajectory of a particular ion species can be “straightened”, see FIGS. 1D(1), 1D(2), 1D(3). This allows the ions of a particular species to pass unhindered between the ion filter electrodes while ions of all other species are deflected into the filter electrodes. The DC voltage that “tunes” the filter and produces a field which compensates for the RF-induced motion is characteristic of the ion species and is called the compensation voltage. A complete spectrum for the ions in the gas sample can be obtained by ramping or sweeping the DC compensation voltage applied to the filter. The ion current versus the value of the sweeping voltage forms the RF-IMS spectra. If instead of sweeping the voltage applied to one of the ion filter electrodes, a fixed DC voltage (compensation voltage) is applied, the spectrometer will work as continuous ion filter allowing only one type of ion through.

By focusing and/or controlling the flow of ions into or along a portion of an ion analyzer, such as an IMS analyzer or the FAIMS analyzer described above, the sensitivity of an ion analyzer may be significantly enhanced because a greater portion of ions can be subjected to analysis. Ion focusing can also enable the use of low flow rate analyzers that require less power, size, and weight to operate.

It is therefore an object of applicants' teachings to provide method and apparatus for improved focusing and control of the flow of ions into or along a portion of an ion analyzer.

### SUMMARY

One approach to improving ion focusing is to employ an ion focusing assembly along the flow path of the ions. The ion focusing assembly may be positioned upstream and/or before the inlet of an ion analyzer such as, for example, a differential mobility spectrometer (DMS), ion mobility spectrometer (IMS), mass spectrometer (MS), or combination thereof.

In another aspect, an dual channel ion mobility based filter may be employed as a pre-filter to an MS to significantly reduce the amount of interferents or other unwanted particles from entering the MS for analysis. The dual channel ion mobility based filter may include at least one of an IMS and DMS. One channel may receive a sample from the surrounding environment, while a second channel may include a pure and/or clean transport gas. After directing a portion of the sample ions from the first channel into the second channel, the ions of the second channel may then be delivered to a MS having a significantly less amount of unwanted particles. Thus, the sensitivity and/or selectivity of the MS may be greatly enhanced.

In a further aspect, a compact analyzer system, having a DMS operating as a pre-filter for a MS, is realized by employing ion focusing at the ion input into the MS, which reduces the size of the MS input orifice, reducing the required flow rate into the MS, which reduces the size and power of a vacuum pump needed to maintain a vacuum in the MS and, thereby, substantially reduces the overall size and power consumption requirements of the DMS-MS analyzer system. Typically, a DMS requires a significantly higher flow rate for sample analysis than a MS. To support the higher flow rate while maintaining sufficient vacuum within the MS, the MS must employ a pump or pumps of sufficient power and capacity to maintain a vacuum. For example, the MS may be required to support a 1 liter/min flow rate from the DMS pre-filter. For smaller DMS-MS systems, the size of the vacuum pump becomes a critical limitation on the overall size of the DMS-MS system. Thus, by employing ion focusing at the MS inlet, a compact DMS-MS analyzer system is realized that may be capable of field operations, be portable, hand-held, with reduced power requirements.

An advantage of employing a DMS with a MS is that the DMS is capable of distinguishing, for example, isomeric and/or isobaric compounds, even though these compounds have the same mass-to-charge (m/z) ratio. Because different isobaric compounds typically have different shapes or structures, different isobaric compounds have different ion mobility characteristics and, therefore, can be distinguished or separated by a DMS. Thus, while a MS alone is not capable of distinguishing different compounds having the same m/z, a DMS-MS system compensates for this problem while retaining the advantages of using a MS. I

In the foregoing description and figures, we address at least the following issues: 1) low flow rate interface for portable MS; 2) effective ion focusing at atmospheric pressure conditions, and 3) dual channel analyzer systems.

The systems and methods described, inter alia, include a sample analysis system including an ion inlet for receiving ions arranged in a plurality of ion streams, an ion detector for detecting the ions and an ion focusing assembly for converging the plurality of ion streams from the ion inlet into at least one focused ion stream, and directing the at least one focused ion stream toward the ion detector, and an atmospheric pressure operated ion pre-filter.

The sample analysis system can include at least one filter channel for focusing at least one ion stream and selectively allowing certain ion species to pass through to the ion detector. In one aspect, the at least one filter channel includes a mobility-based filter. The mobility-based filter can be selected from the group consisting of cylindrical FAIMS, planar DMS, IMS and aspiration DMA.

In one aspect, the ion focusing assembly includes a first grid having at least one opening through which ions may flow, a second grid having at least one opening through which ions may flow, a first and second DC voltage source, and a time varying voltage source. In another aspect, the ion focusing assembly includes first and second electrodes for applying an electric field perpendicular to the ion stream. In another aspect, the ion focusing assembly includes first and second pairs of electrodes for applying an electric field between the first pair of electrodes and the second pair of electrodes, wherein the electric field is parallel to the ion stream.

In one aspect the ion detector includes an analytical instrument including an inlet orifice for ion detection. In one aspect, the ion detector includes a mass spectrometer including an inlet orifice. In an aspect, directing the at least one focused ion stream includes focusing the focused ion stream into a narrow ion stream along a longitudinal axis directly into the inlet orifice of the mass spectrometer. In one aspect. The orifice diameter is less than about one of 100 microns, 75 microns, 50 microns, 25 microns, 20 microns, 10 microns and 5 microns.

In one aspect, directing includes focusing the focused ion stream into a narrow ion stream along a longitudinal axis directly into the inlet of the ion mobility based filter. The sample analysis system can include a low-power sucking pump optimized for enabling an appropriate flow rate for DMS operation, ion focusing and flow into the ion detector. In one aspect, the ion focusing assembly comprises a deflector electrode for deflecting ions at a right angle toward the ion detector, and for preventing analyte neutrals from being introduced into the ion detector.

The systems and methods described, inter alia, include a method for analyzing a sample including receiving ions at an ion inlet, passing the ions through an ion focusing assembly and converging the ions into at least one focused ion stream, passing the ions through an atmospheric pressure operated ion pre-filter, and passing the at least one focused ion stream to an ion detector. Passing the ions through an ion focusing assembly can include passing the ions through a first grid via at least one opening, converging the ions, using the ion focusing assembly, into at least one focused ion stream and passing the at least one focused ion stream through a second grid via at least one opening into at least one filter channel.

In one aspect, passing the ions through an ion focusing assembly includes passing the ions through an electric field perpendicular to a flow of the ions, and converging the ions, using the ion focusing assembly, into at least one focused ion stream. In one aspect, passing the ions through an ion focusing assembly includes passing the electrodes through an electric field parallel to a flow of the ions, and converging the ions, using the ion focusing assembly, into at least one focused ion stream.

In one aspect the method for analyzing a sample includes applying a DC bias voltage to at least one of the first and second grids. The DC bias voltage can be selected from the group consisting of a ground voltage, a reference voltage, a positive voltage and a negative voltage.

In one aspect the method for analyzing a sample includes applying a difference in DC potentials across the first and second grids thereby generating an electric field between the first and second grids, and converging the ions into at least one focused ion stream using the electric field between the first and second grids.

In another aspect the method for analyzing a sample includes applying a time-varying voltage across the first and second grids, and converging the ions into at least one focused ion stream using the time-varying voltage across the first and second grids.

The systems and methods described, inter alia, include a system for analyzing a sample including means for receiving ions at an ion inlet, means for passing the ions through an ion focusing assembly and converging the ions into at least one focused ion stream, and means for passing the at least one focused ion stream to an ion detector.

In one aspect, passing the ions through an ion focusing assembly includes means for passing the ions through a first grid via at least one opening, means for converging the ions, using the ion focusing assembly, into at least one focused ion stream, and means for passing the at least one focused ion stream through a second grid via at least one opening into at least one filter channel.

In one aspect, passing the ions through an ion focusing assembly includes means for passing the ions through an electric field perpendicular to a flow of the ions, and means for converging the ions, using the ion focusing assembly, into at least one focused ion stream. In another aspect, passing the ions through an ion focusing assembly includes means for passing the ions through an electric field parallel to a flow of the ions, and means for converging the ions, using the ion focusing assembly, into at least one focused ion stream.

The system for analyzing a sample can include a means for applying a DC bias voltage to at least one of the first and second grids. The DC bias voltage can be selected from the group consisting of a ground voltage, a reference voltage, a positive voltage and a negative voltage.

In one aspect, the system for analyzing a sample includes means for applying a difference in DC potentials across the first and second grids thereby generating an electric field between the first and second grids; and means for converging the ions into at least one focused ion stream using the electric field between the first and second grids. The system for analyzing a sample can include means for applying a time-varying voltage across the first and second grids, and means for converging the ions into at least one focused ion stream using the time-varying voltage across the first and second grids.

### BRIEF DESCRIPTION OF THE DRAWINGS

The foregoing and other objects, features and advantages of applicants' teachings will be apparent from the following more particular description of preferred embodiments of applicants' teachings, as illustrated in the accompanying drawings in which like reference characters refer to the same parts throughout the different views. The drawings are not necessarily to scale, emphasis instead being placed upon illustrating the principles of applicants' teachings.

FIG. 1A shows the mobility dependence on electric field for three different ion species.

FIG. 1B shows the trajectories of ions in the gap between the upper and lower parallel plate electrodes of the ion filter, under the simultaneous influence of the carrier gas flow and an asymmetric radio frequency electric field waveform.

FIG. 1C shows a simplified asymmetric RF electric field waveform used for ion filtering.

FIG. 1D1 shows compensation voltage applied to cancel out displacement produced by RF-field.

FIG. 1D2 shows the trajectory of ion from initial position with only the RF field applied and the trajectory of ion with only the compensation field applied.

FIG. 1D3 shows the trajectory of ion with both RF and compensation fields applied.

FIG. 2 is a schematic of a chemical sensor system according to an illustrative embodiment of applicants' teachings.

FIG. 3A shows a chemical sensor system with liquid sample preparation section including an electrospray according to an illustrative embodiment of applicants' teachings.

FIG. 3B shows a chemical sensor system with liquid sample preparation section including an electrospray according to an illustrative embodiment of applicants' teachings.

FIG. 3B1 shows a machined electrospray head according to an illustrative embodiment of applicants' teachings.

FIG. 3C shows a serpentine electrode according to an illustrative embodiment of applicants' teachings.

FIG. 3D shows the substrates forming a housing according to an illustrative embodiment of applicants' teachings.

FIG. 4A shows a FAIMS spectrometer with spaced insulated substrates according to an illustrative embodiment of applicants' teachings.

FIG. 4B shows an alternative structural electrode embodiment according to an illustrative embodiment of applicants' teachings.

FIG. 4C shows side cross-sectional view of filter with insulating spacers overlapping edges of electrodes according to an illustrative embodiment of applicants' teachings.

FIG. 4D shows an electrospray head with a sample reservoir feeding a separation channel leading to a spray tip according to an illustrative embodiment of applicants' teachings.

FIG. 5A shows symmetric AC radio frequency field for ion desolvation according to an illustrative embodiment of applicants' teachings.

FIG. 5B shows the desolvation region integrated into a FAIMS device according to an illustrative embodiment of applicants' teachings.

FIG. 6 shows a prior art cylindrical FAIMS connected to a mass spectrometer.

FIGS. 7A and 7B show improved cylindrical FAIMS devices according to an illustrative embodiment of applicants' teachings.

FIG. 8 shows an electrospray mounting tower according to an illustrative embodiment of applicants' teachings.

FIG. 9A shows an electrospray head cooperating with guiding electrodes according to an illustrative embodiment of applicants' teachings.

FIG. 9B shows an electrospray head cooperating with guiding electrodes according to an illustrative embodiment of applicants' teachings.

FIG. 10A shows the control system according to an illustrative embodiment of applicants' teachings.

FIG. 10B shows control signals according to an illustrative embodiment of applicants' teachings.

FIG. 11A shows a chip receptacle according to an illustrative embodiment of applicants' teachings.

FIG. 11B shows a chip receptacle interfaced with a mass spectrometer according to an illustrative embodiment of applicants' teachings.

FIGS. 12A and 12B show planar FAIMS according to an illustrative embodiment of applicants' teachings.

FIGS. 12C and 12D show prior art cylindrical FAIMS devices.

FIGS. 13A and 13B show an electrospray tip inserted within the ion region, either from above through orifice in upper substrate or from the side according to an illustrative embodiment of applicants' teachings.

FIGS. 14A and 14B show longitudinal electric field driven embodiments according to an illustrative embodiment of applicants' teachings.

FIGS. 15A and 15B show split gas flow embodiments according to an illustrative embodiment of applicants' teachings.

FIG. 16 shows a dual channel embodiment according to an illustrative embodiment of applicants' teachings.

FIG. 17 shows dependence of Ketones on compensation voltage for different ionization sources according to an illustrative embodiment of applicants' teachings.

FIG. 18 shows a dual channel embodiment according to an illustrative embodiment of applicants' teachings.

FIG. 19 shows detection spectra according to an illustrative embodiment of applicants' teachings.

FIG. 20 shows an ion mobility based analyzer system including a ion focusing assembly according to an illustrative embodiment of applicants' teachings.

FIG. 21 shows a sample analysis system including a dual channel mobility spectrometer as a pre-filter to a mass spectrometer according to an illustrative embodiment of applicants' teachings.

FIG. 22 shows a block diagram of a dual channel system according to an illustrative embodiment of applicants' teachings.

FIGS. 23A-23C show plots of ion intensity vs. compensation voltage of an ion mobility filter according to an illustrative embodiment of applicants' teachings.

FIGS. 24A-24C show plots that illustrate the coefficient of transfer from a first channel to a second channel in an ion mobility filter for Toluene and SF6 when the deflector electrodes are biased positively and negatively according to an illustrative embodiment of applicants' teachings.

FIG. 25 shows a typical prior art DMS-MS system utilizing high flow consumption in the MS.

FIG. 26 shows a DMS-MS system including a DMS pre-filter supporting low flow rate Atmospheric Pressure Interface for an MS according to an illustrative embodiment of applicants' teachings.

FIG. 27 shows a DMS-MS system including an ion focusing assembly according to an illustrative embodiment of applicants' teachings.

FIG. 28 shows a DMS-MS system including a low power sucking pump according to an illustrative embodiment of applicants' teachings.

FIG. 29 shows a DMS-MS system including an MS interface and orifice positioned out of line from the DMS flow according to an illustrative embodiment of applicants' teachings.

FIGS. 30A-30C show examples of an ion focusing assembly according to an illustrative embodiment of applicants' teachings.

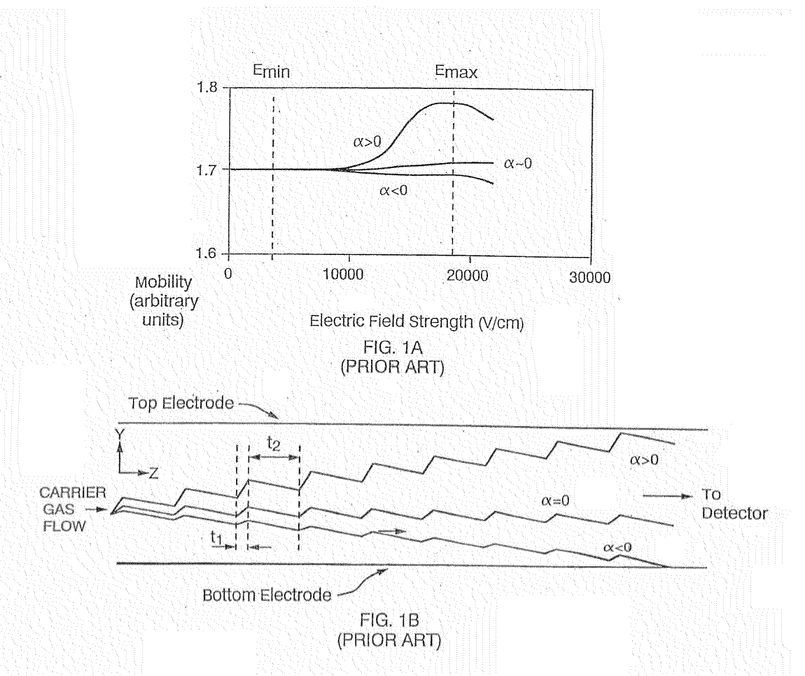

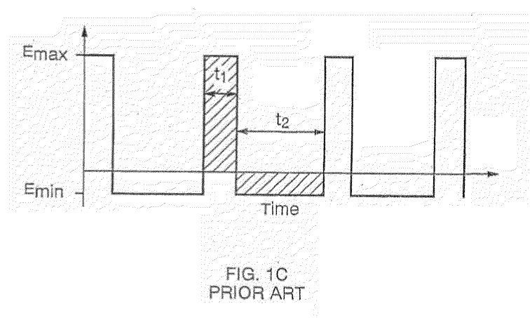

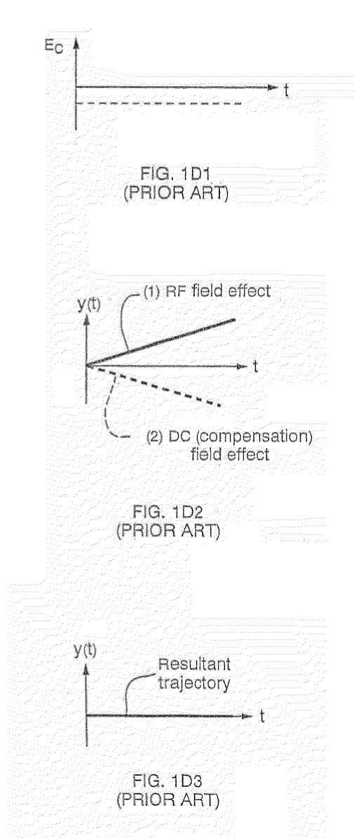

### ILLUSTRATIVE DESCRIPTION

A description of preferred embodiments of applicants' teachings follows. Applicants' teachings provide a method and apparatus for analysis of compounds in a liquid sample, preferably enabled by high field asymmetric waveform ion mobility spectrometry.

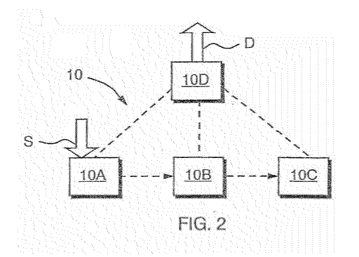

In an illustrative embodiment of the applicants' teachings shown in FIG. 2, a chemical sensor system 10 includes a sample preparation section 10A, a filter section 10B, and an output section 10C. In practice, a liquid sample S is ionized in sample preparation section 10A, the created ions then being passed to and filtered in filter section 10B, and then ions passing through the filter section are delivered to output section 10C for detection. The liquid sample preparation section 10A, filter section 10B, and output section 10C operate under control and direction of controller section 10D. Preferably controller section 10D controls both the operation of system 10 and appraises and reports detection data D.

In a preferred embodiment of applicants' teachings, the liquid sample preparation section 10A includes an electrospray head, which receives, conditions, and ionizes liquid sample S. This is transported to a preferred planar high field asymmetric ion mobility spectrometer (PFAIMS) filter in section 10B, the latter filtering the delivered ions and passing ion species of interest to output section 10C. In various embodiments of applicants' teachings, function in output section 10C may include immediate detection of ion species or transfer of ions to another component such as a mass spectrometer (MS) for detection of ion species thereat, with a readout being available of data D indicative of detected ion species.

As will be understood by a person skilled in the art, the FAIMS filter with planar surfaces is preferred in embodiments of applicants' teachings, but embodiments of applicants' teachings are operable with various non-planar parts and surfaces, including filters, detectors, flow paths, electrodes, and the like. The description herein of PFAIMS is by way of illustration and not limitation.

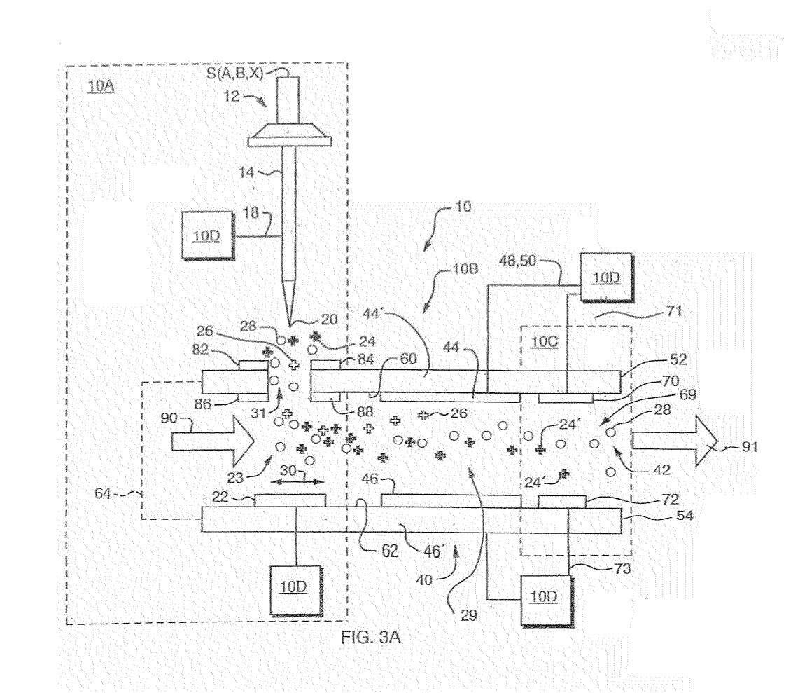

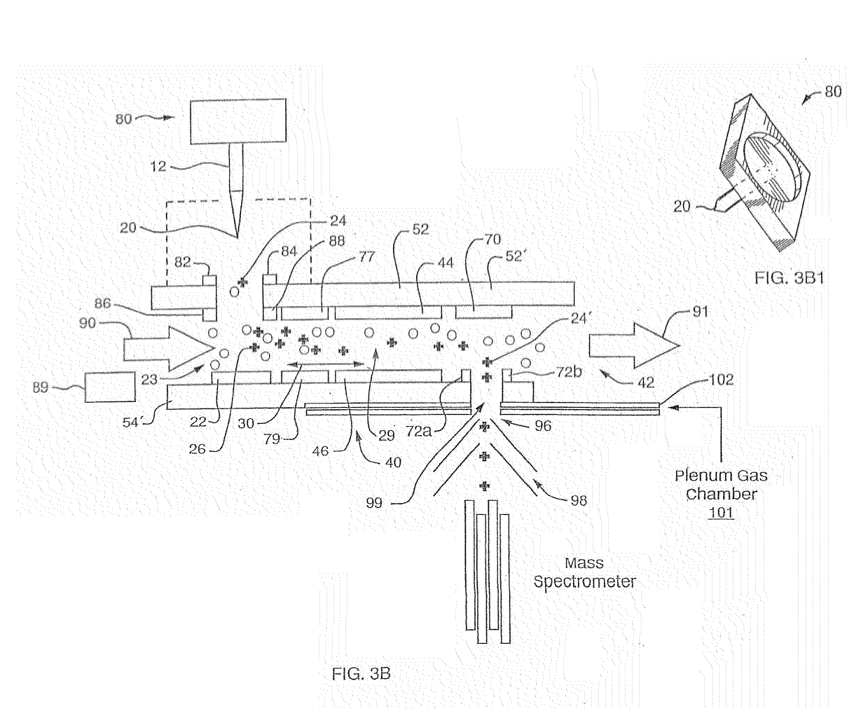

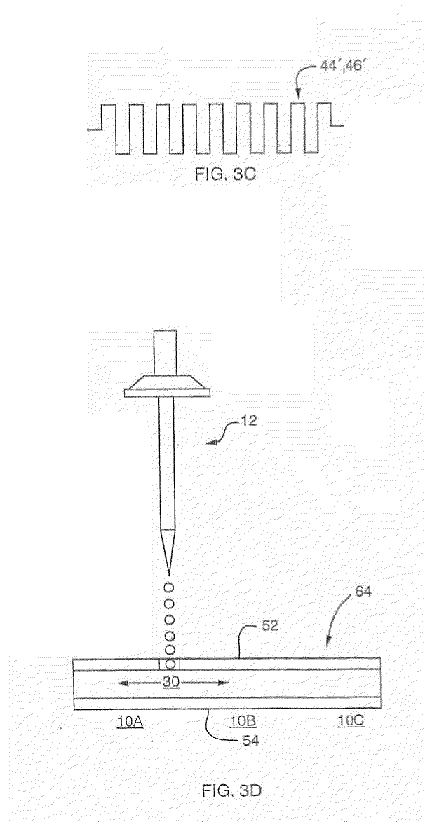

In the embodiments of FIG. 3A, 3B, liquid sample preparation section 10A includes electrospray sample ionization source or head 12 having a chamber 14 for receipt of liquid sample S. In practice of applicants' teachings, the liquid sample S may contain bio-compounds, for example compounds A and B, in a solvent X. Applicants' teachings are engaged to identify one or more of the compounds in the liquid sample.

In practice of the electrospray device of section 10A, a high voltage potential 18 is applied by controller 10D to the liquid sample S within chamber 14 of electrospray head 12. The potential difference between the liquid sample S at electrospray tip 20 and attraction electrode 22, driven by controller 10D, ionizes compounds A, B in solvent X in sample S in ion region 23. This creates ions 24 and 26, representing compounds A and B, and solvent molecules 28. In a preferred embodiment, ions and solvent are driven or drawn along flow path 30 into filter section 10B between the parallel filter electrodes 44, 46 of PFAIMS ion filter 40.

Filtering in the PFAIMS filter device 40 is based on differences in ion mobility, which is influenced by ion size and shape, among other items. This enables separation of ion species based on their characteristics. In one practice of applicants' teachings, a high intensity asymmetric waveform radio frequency (RF) signal 48 and a DC compensation signal 50 are applied to filter electrodes 44, 46 by RF/DC generator circuits within controller 10D. The asymmetric field alternates between a high and low field strength condition that causes the ions to move in response to the field according to their mobility. Typically the mobility in the high field differs from that of the low field. This mobility difference produces a net transverse displacement of the ions as they travel longitudinally through the filter between the filter electrodes. In the absence of a compensating bias signal, these ions would hit one of the filter electrodes and be neutralized. In the presence of a selected compensating bias signal 50 (or other compensation), a particular ion species will be returned toward the center of the flow path and will pass through the filter. Therefore, in the presence of the compensated asymmetric RF signal 48, separation of ions from each other according to their species can be achieved. Unselected species will hit the electrodes and be neutralized and species of interest will be passed through the filter. The data and system controller 10D regulate the signals 48, 50 applied to the filter electrodes 44, 46, in order to select which ion species pass through the filter.

It will be appreciated that it is desirable to isolate ions 24 and 26 to be able to obtain unambiguous identification of either or both of compounds A and B, as can be achieve with the PFAIMS filter 40. The PFAIMS filter 40 discriminates between ions A and B based on their mobility, such that in principle only one or the other is presented for detection at output section 10C according to the compensation applied by controller 10D. For example, ions 24 are shown as ions 24′ passed by filter 40 in FIG. 3A, 3B.

Referring again to FIG. 3A, 3B, the output section 10C includes detector 69 with detector electrodes 70, 72. Controller 10D measures the current on electrodes 70, 72 as an indication of ions passed by filter 40. These electrodes are held at a potential by bias signals 71, 73, from controller 10D. Ions 24′ which passed filter 40 deposit their charge on a detector electrode 70, 72 under control of controller 10D, depending upon the polarity of the electrode and the control signals 71, 73 on the detector electrodes. Furthermore, by sweeping the compensation (i.e., the bias voltage), a complete spectrum of ion species in Sample S can be detected.

By intelligent control of controller 10D it is possible to select different operating regimes and as a result it is possible to target the filtering of ion species of interest. In practice of one embodiment of applicants' teachings, the asymmetric electric signal 48 is applied in conjunction with compensating bias voltage 50, and the result is that the filter passes desired ion species as controlled by electronic controller 10D. As well, by sweeping bias voltage 50 over a predetermined voltage range, a complete spectrum of ion species in sample S can be achieved.

In another embodiment, the asymmetric electric signal enables passing of the desired ion species where the compensation is in the form of varying the duty cycle of the asymmetric electric signal, without the need for compensating bias voltage, again under direction of the control signals supplied by the electronic controller. By means of these features, the apparatus is also tunable, i.e., it can be tuned to filter ion species, passing only desired selected species to the detector.

A further advantage of applicants' teachings is that the filter can pass multiple ion species with similar mobility but different polarity, and these can be detected simultaneously. If each detector electrode 70, 72 is held at a different polarity, then multiple ion species (having similar mobility but different polarity) that pass through the filter can be detected simultaneously. Detected ions are correlated with the applied control signals 48, 50 and potential bias signals 71, 73 to determine the species of detected ion(s) indicated at data D, FIG. 2.

This multi-functionality may be further understood by reference to output section 10C, such as in FIG. 3A, where a top electrode 70 is held at a predetermined voltage at the same polarity as the ions of interest passed by filter 40 while bottom electrode 72 is held at another level, perhaps at ground. Top electrode 70 deflects ions 24′ downward to electrode 72 for detection. However, either electrode may detect ions depending on the ion charge and polarity and the signal applied to the electrodes. Thus multiple ion species having similar mobility but different polarity that pass through the filter can be detected simultaneously by using top electrode 70 as one detector and bottom electrode 72 as a second detector, and using two different detector circuits in controller 10D, with two different outputs thus emitted. Detector 69 may thus detect simultaneously multiple species passed by the PFAIMS filter 40, such as a gas sample including sulfur in a hydrocarbon gas background.

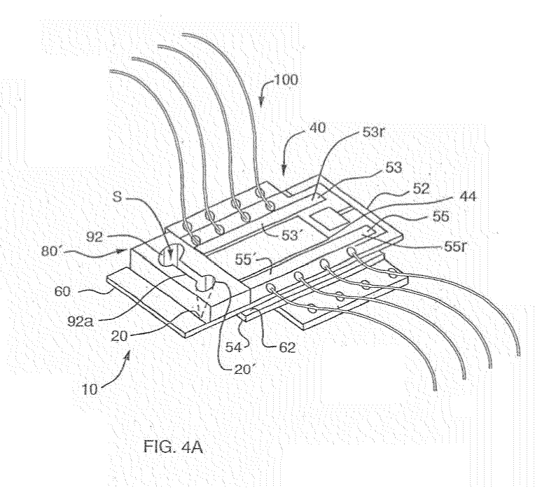

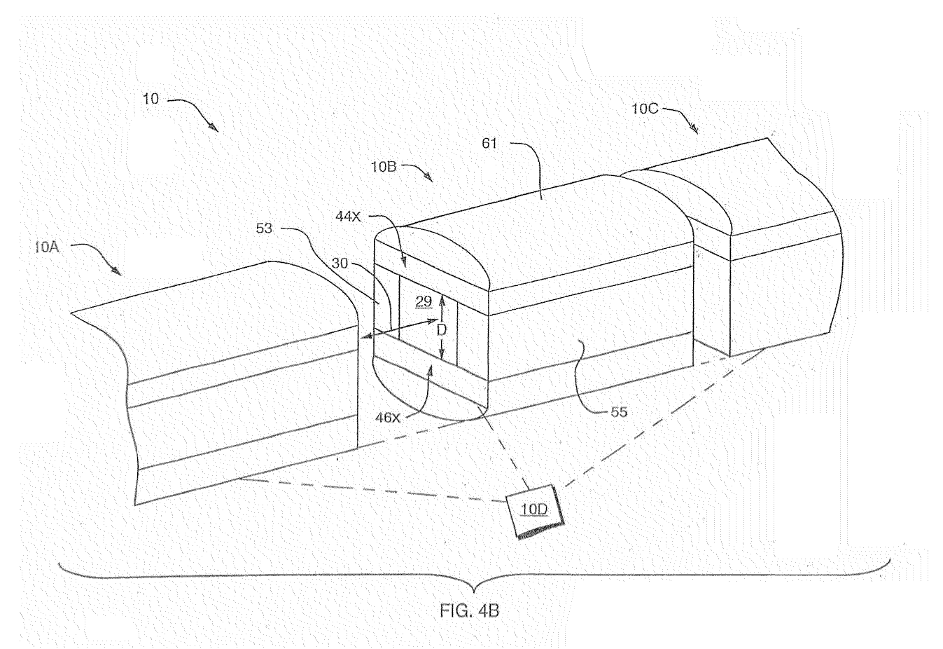

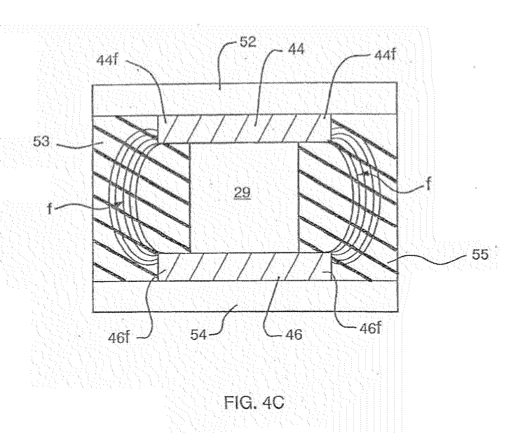

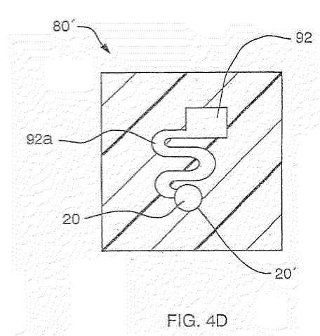

The electronics controller 10D supplies the controlling electronic signals to system 10. A control circuit could be on-board, or off-board, where the PFAIMS device has a control part with at least the leads and contact pads shown in FIG. 4A that connect to the control circuit 10D. The signals from the controller are applied to the filter electrodes via such connections.

In the embodiment of FIG. 4A, a PFAIMS system 10 includes a spectrometer chip 100 having spaced insulated substrates 52, 54, (e.g., Pyrex® glass, ceramic, plastic and the like) with filter electrodes 44, 46 formed thereon (of gold or the like). Substrates 52, 54, define between themselves the drift tube 29 and flow path 30, thus performing a housing function. Preferably the substrates are insulating or have surfaces 60, 62 for insulated mounting of electrodes. Electrodes 44, 46 form ion filter 40, with the filter electrodes mounted on these insulated surfaces 60, 62 facing each other across the flow path 30.

As shown in FIG. 4A, 4B, 4C, substrates 52, 54 are separated by spacers 53, 55, which may be insulating and formed from ceramic, plastic, Teflon® or the like, or may be formed by etching or dicing silicon wafers, or creating an extension of the substrates 52, 54, for example. The thickness of the spacers defines the distance “D” between the faces of substrates 52, 54 carrying electrodes 44, 46. In one embodiment of FIG. 4A, the silicon spacers can be used as electrodes 53′, 55′ and a confining voltage is applied by controller 10D to the silicon spacer electrodes to confine the filtered ions within the center of the flow path. This confinement can result in more ions striking the detectors, and which in turn improves detection.

In a further alternative embodiment of applicants' teachings shown in FIG. 4B, alternative structural electrodes 44x, 46x, take the place of the substrates 52, 54, and are mounted at and separated by insulating spacers 53, 55, forming flow path 30 within. At one end of the flow path, sample preparation section 10A supplies the ions to the filter section 10B, and at the other end, the filtered ions pass into an output section 10C. In the same manner that the substrates serve a structure function and form a housing, so too the structural electrodes 44x, 46x serve the function of a housing, as well as being electrodes. As with the substrates, the outer surface of these electrodes may be planar or not, and may be covered by an insulated surface 61.

In the embodiment of FIG. 4C, shown in side cross-section, the insulating spacers 53, 55 overlap with the edges 44f, 46f of filter electrodes 44, 46. This ensures that the ions flowing in flow path (i.e., drift tube) 29 are confined to a region of uniform transverse electric field between the filter electrodes 44, 46, away from the electrode edges 44f, 46f where the non-uniform fringing field “f” is present. A further benefit is that all ions are forced to pass between the filter electrodes, and are subjected to that uniform field.

Returning to FIG. 3A, in operation, ions 24, 26 flow into the filter 40. Some ions are neutralized as they collide with filter electrodes 44, 46. These neutralized ions are generally purged by the carrier gas. Purging can also be achieved, for example, by heating the flow path 30, such as by applying a current to appropriately configured filter electrodes (e.g., serpentine 44′,46′ shown in FIG. 3D) or to resistive spacer electrodes. Spacer electrodes 53, 55 of FIG. 4A could be formed with resistive material and therefore could be used as heatable electrodes 53r, 55r.

Ions 24 are passed to output section 10C of FIG. 3A. Exhaust port 42 is provided to exhaust the molecules 28 from the passed ions 24. This isolation of ions 24 eases the detection function and enables more accurate chemical analysis. But even with this precaution, some solvent molecules may remain attached to the ions of interest 24. Therefore, in a preferred embodiment, apparatus is provided to desolvate ions such as 24 and 26 prior to their filtering. Desolvation may be achieved by heating. For example, any of electrodes 44, 46, 53r, 55r, may have a heater signal applied thereto by controller 10D. In another embodiment incoming gas flow may be heated by heater element 89 as shown in FIG. 3B.

It will be appreciated by those skilled in the art that desolvation or “drying” of electrosprayed ions is a critical part of the electrospray process. When the ion is first ejected out the electrospray tip it is in the form of a droplet with a large amount of solvent coating the ion. As it travels through the air towards a counter electrode the solvent evaporates eventually leaving the desolvated ion which can then be analyzed. Incomplete desolvation prior to analysis can distort the analysis. Additionally, a long ion travel distance may be required to allow the ion to sufficiently desolvate, without some other assistance. It will therefore be appreciated that this desolvation is beneficial in practice of applicants' teachings.

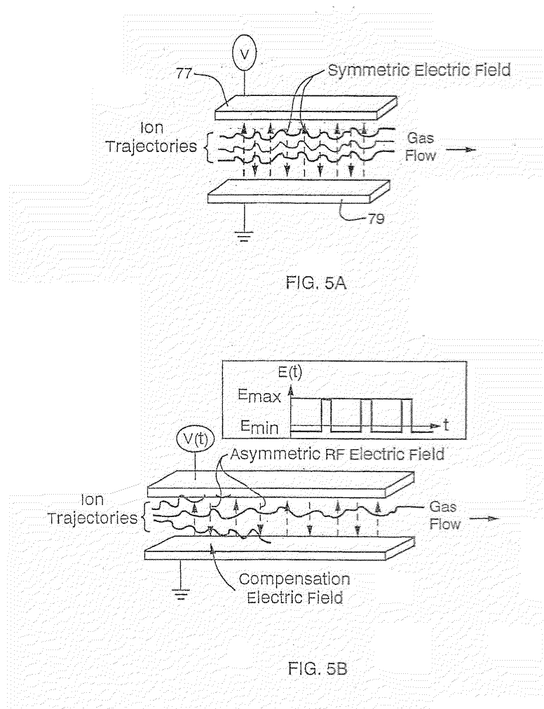

In another embodiment of applicants' teachings, a symmetric RF-electric field is used to enhance desolvation of ions produced in the electrospray prior to analysis. As shown in FIG. 5A, 5B, a symmetric radio frequency field applied perpendicularly to the carrier gas flow to cause the ions generated in the electrospray process to oscillate symmetrically, and be heated, as they travel down the drift tube so that the ions are desolvated without net deflection from this signal.

More particularly, the interaction between the ions and the neutral molecules raises their effective temperature, enhancing their desolvation. During their oscillations the ions will impact neutral air molecules and their internal temperature will increase. The rise in the internal temperature of the ions enhances the evaporation of the solvent and shortens the time to realize a desolvated charged ion. This action enables desolvation to be done over a relatively short length of the drift tube. Desolvation results in more accurate detection data, and the above approach is easily integrated with the PFAIMS filter of applicants' teachings.

The desolvating electric field can be generated by applying a voltage between two electrodes configured parallel to each other with a gap between them. For example, any of electrode pairs 44, 46 and 53, 55 may be used for this function, under control of controller 10D. Preferably separate desolvation electrodes 77, 79, as shown in FIG. 3B may be used for this function.

In a further embodiment of applicants' teachings, a micromachined electrospray head 80 is mounted on substrate 52, shown schematically in FIGS. 3B and 3B1. Electrodes 82, 84, 86, 88 are formed on opposite sides of substrate 52 and guide the electrospray ions 24, 26 into ion region 23 of flow path 30 in drift tube 29. Attraction electrode 22 has a potential applied thereto to attract the ions 24, 26 into the ion region 23. Carrier gas flow 90 is set at a desired flow rate to capture ions 24, 26 and to carry them to filter 40 for the filtering function already described. The gas exhaust 91 includes the carrier gas 90 and carries away non-ionized components and neutralized ions.

Potentials applied to electrodes 22, 82, 84, 86, 88, and even desolvation electrodes 77, 79, can be set and controlled independent of each other and of the filter electrodes 44, 46. For example, this advantageously enables the attractor electrode 22 to be driven with a different signal than any other electrode, such as the adjacent filter electrode 46. This is particularly facilitated by provision of the insulated surfaces of the substrates, and the electrode isolation allows optimization of ion introduction independent of filter drive requirements.

This configuration also enables the guiding electrodes 82,84, 86, 88 and attractor electrode 22 to be individually operated in a pulsed mode (e.g., switched on and off). In this mode, a select amount of ions can be introduced into the ion region 23. The time these ions travel, such as from the orifice to detector 72 for example, can be used in a “time-of-flight” (“TOF”) FAIMS mode of operation. In this mode, the time of flight is associated with ion species, thus providing additional information for species discrimination. This leads to an improvement in cylindrical FAIMS devices.

As will be appreciated by a person skilled in the art of IMS, this TOF is an analog to the time-of-flight practiced in IMS devices, but now being practiced within a FAIMS structure. This new innovation may therefore provide both IMS and FAIMS detection data in one operating device; the combination of FAIMS and IMS data can yield better detection results.

In preferred embodiments, such as shown in FIGS. 3A-3B, 4A-4B, the housing 64 is formed by substrates 52, 54, with internal flow path 30 defined extending from the input part 10A, through the ion filter 10B, to the output part 10C. More particularly, substrates 52, 54 present work surfaces 60, 62, which favor formation of electrodes thereat. These surfaces 60, 62 may be curved or planar and preferably insulating (or insulated), such as when formed using glass or ceramic substrates for example. This lends itself to mass manufacturing techniques such as Micro-Electro-Mechanical Systems (MEMS) or Multi-Chip Module (MCM) or other processes, with a result of very compact packaging and small electrode sizes. As such, the ion filter is preferably defined on these insulated surfaces by the facing filter electrodes 44, 46 with the flow path 30 defined in between, and the insulated surfaces of the substrates in turn then isolating the control signals 48, 50 at the filter electrodes from detector electrodes 70, 72, for lower noise and improved performance. This is unlike the extensive conductive area of the outer cylinder of conventional prior art FAIMS devices, such as in U.S. Pat. No. 5,420,424, incorporated herein by reference.

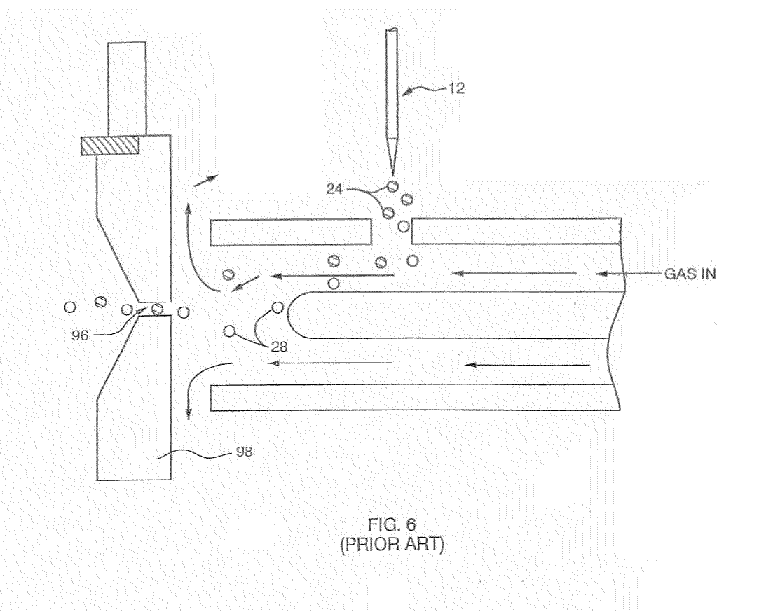

It will be further understood that due to geometrical and physical considerations, the ions in prior art cylindrical designs are distributed in the drift tube cross-section and therefore only a fraction of ions are available in the region R near the mass spec inlet 96. In the prior art configuration of a cylindrical FAIMS shown in FIG. 6 (see PCT/CA99/00715, incorporated herein by reference), an attempt is made to overcome this limitation by enabling additional delivery of ions to the mass spectrometer inlet 96. However neutral sample molecules can also enter into the mass spectrometer inlet 96 because there is no separation between the sample ions 24 and neutral molecules, such as solvent molecules 28. This leads to significantly more complex spectra in the mass spectrometer, and degraded resolution.

Applicants' teachings overcome these shortcomings in the configuration of FIG. 3B, for example. In practice of applicants' teachings, virtually all of the ions 24 entering the detector region 69 are focused into the mass spec inlet 96. This results in a dramatic increase in efficiency of detection and improved sensitivity of the system, especially compared to a cylindrical FAIMS device where ions are distributed around the entire flow path circumference, not just at the MS inlet.

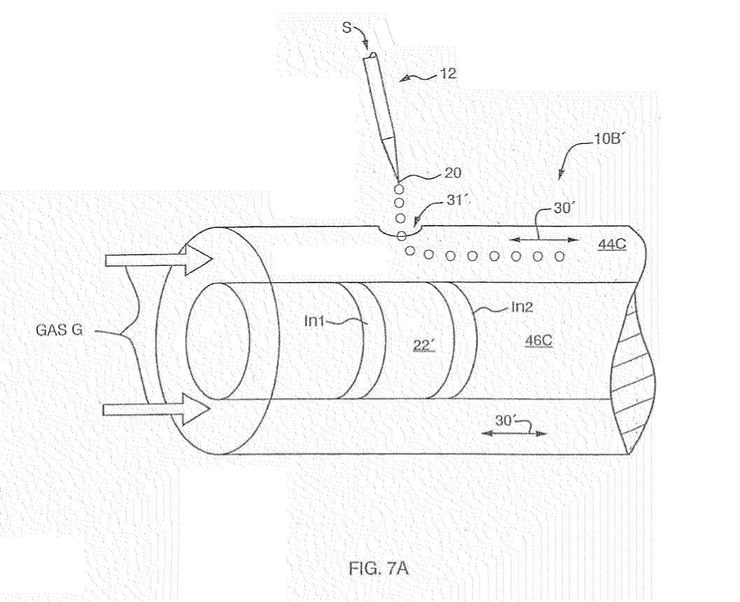

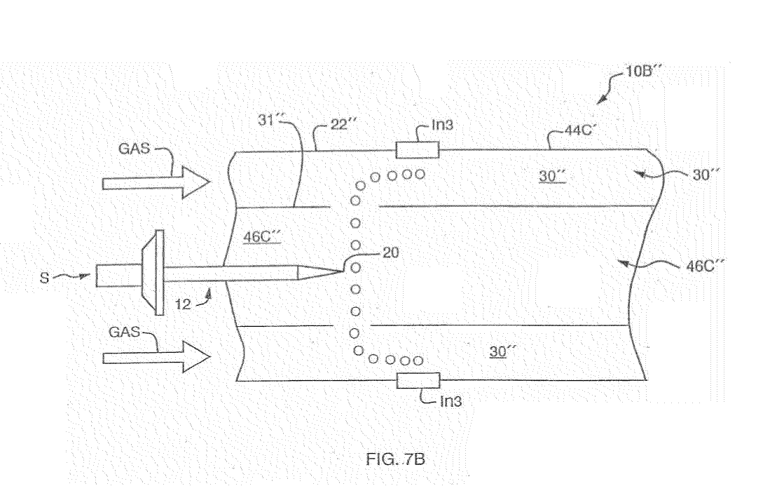

Furthermore, referring to a new cylindrical design of applicants' teachings, shown in FIG. 7A, electrospray tip 20 injects samples via orifice 31′ in outer electrode 44C into flow channel 30′, under attraction of attractor electrode 22′, and the sample is carried by the flow of gas G toward the filter section 10B′. The attractor electrode is formed adjacent to the inner electrode 46C but electrically isolated by insulator strips In1, In2. Therefore the attractor electrode can be independently biased separate from neighboring electrodes, e.g., 46C. This embodiment also combines functional and structural components while reducing parts count, such as where the inner cylinder components can be mated together via a binding function of the insulating layers In1, In2, for example.

In an alternative embodiment shown in FIG. 7B, an attractor electrode 22″ is formed adjacent to outer ring electrode 44C′, insulated therefrom by insulator ring In3. The electrospray tip 20 introduces sample S from the side into the interior of a ring 46C″, which may be a separate electrode, or may be an extension of inner electrode 46C′, with the sample under attraction of attractor electrode 22″ and being carried by gas G in flow channel 30″ of filter section 10B″. Again, electrode 22″ is isolated from electrode 44C′ by insulator In3, and therefore the electrodes are independently drivable.

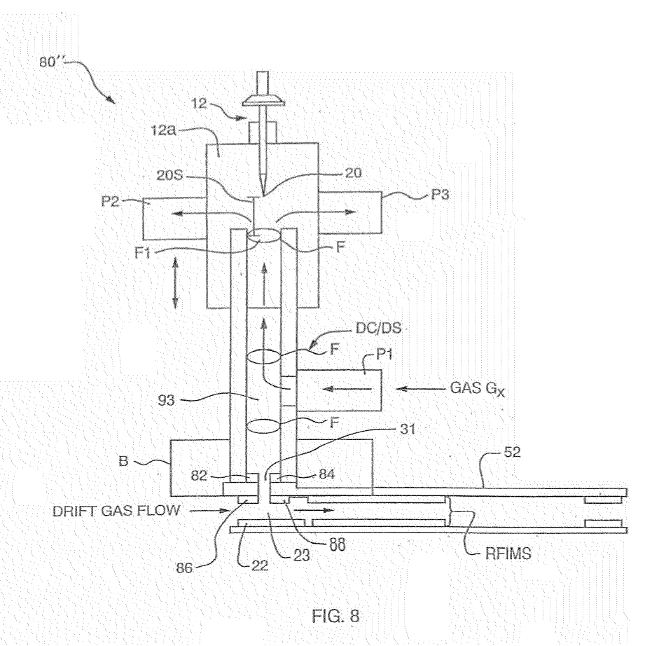

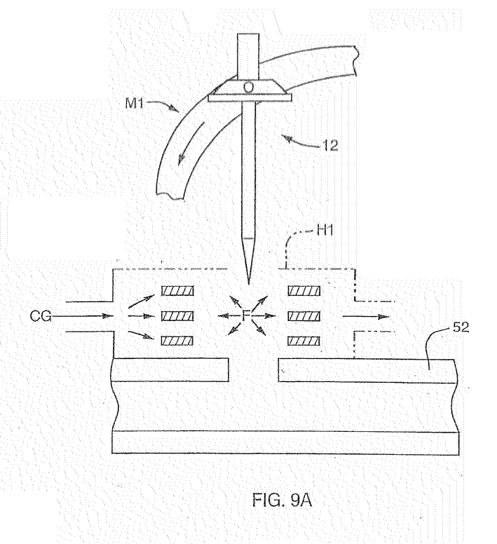

In a further embodiment of applicants' teachings shown in FIG. 8, electrospray assembly 80″, attached to substrate 52, includes electrospray head 12. The ions are carried by guiding electrodes “F” (three in this embodiment), toward orifice 31 and are attracted into ion region 23 by attraction electrode 22 and guiding electrodes, such as 82, 84 and/or 86, 88.

Preferably a separate DC bias “DC” is applied to each guiding electrode to create a potential gradient which guides the ions towards ion region 23. The guiding electrodes can be used for a further function by also applying symmetric RF signals “DS” to enhance desolvation, as earlier discussed.

Cleansing gas G is introduced at port P1 to further enhance desolvation. This gas flows opposite to the guided ions in chamber 93 and exhausts out ports P2, P3. Preferably, this is operated with no pressure gradient across orifice 31.

In order to improve spray conditions, the separation 20S between the tip 20 and the top guiding electrode F1 can be adjusted in practice of applicants' teachings. In one practice, the position of housing 12a can be adjusted relative to base B, which in turn adjusts the separation 20S. In an alternative, the height of head 12 can be adjusted relative to electrode F1.

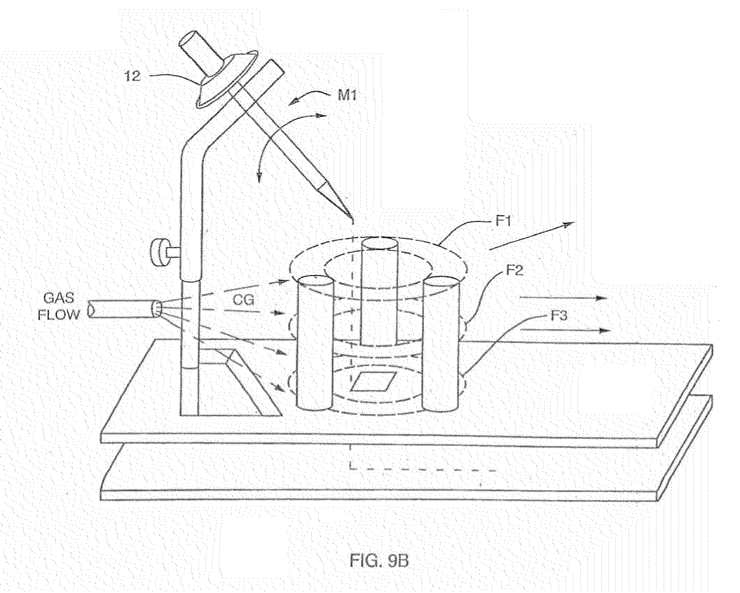

In an alternative embodiment, as shown in FIGS. 9A and 9B, spaced apart guiding electrodes F (FIG. 9A) or F1, F2, F3 (FIG. 9B) are bathed in a curtain gas flow CG. This flow may be unconfined or contained within housing H1. The electrospray head 12 is adjustably mounted in mount M1, wherein its angle of delivery can be adjusted relative to the surface of substrate 52. In addition, its height can be adjusted relative to the substrate.

Referring again to FIG. 4A, sample reservoir 92 receives a liquid sample S, which is then ionized and filtered as set forth above. In such embodiment, a single spectrometer chip 100 integrates both a ionization source, such as part of a microfluidic electrospray module 80′, and planar high field asymmetric waveform ion mobility filter 40. An internal detector may also be included, or ions are outputted for detection. Various micro-fabricated micro-fluidic components may be used as an ion source, or combinations thereof, including electrospray, nano-electrospray, liquid chromatography, electrophoresis separation.

In another embodiment, the electrospray head 80′ of FIG. 4A may be attached to substrate 52 (preferably through anodic bonding or brazing). Guiding electrodes 82 and 84 are not required in this embodiment.

In the embodiment of FIG. 4D, the microfluidic electrospray module 80′ includes sample reservoir 92 feeding a lengthened, serpentine, separation channel 92a, leading to tip orifice 20′ and then to tip 20. The channel 92a may be a liquid chromatograph or electrophoretic separator, or the like, for conditioning or separating constituents in the sample prior to ionization at the tip 20.

The motivation for such a chip 100, with or without a microfluidic module, is to eliminate variability in sample preparation and analysis, this is achieved by reducing human interaction and by providing a device that incorporates all key components in a single structure. These chips 100 lend themselves to low cost manufacturing and as a result can be disposable. Using a new chip for each sample analysis eliminates sample to sample cross-contamination. Additionally, through the reduction in human intervention, sample preparation time is reduced. In a conventional arrangement the position of the electrospray tip or micro-fluidic component, must be re-adjusted each time relative to any filter or mass spectrometer inlet. This adds time and cost. With the integrated micro-fluidics chip/PFAIMS apparatus of applicants' teachings, the relative positions of the micro-fluidic components and PFAIMS inlet are fixed. Once analysis is completed the entire chip is simply discarded and a new chip is loaded with a sample to be analyzed and possibly to be mounted on a mass spectrometer. This allows for significantly faster analysis times and higher throughput.

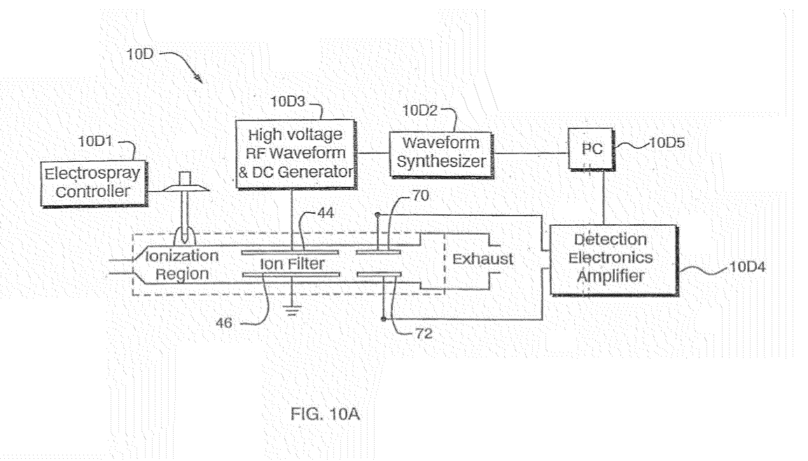

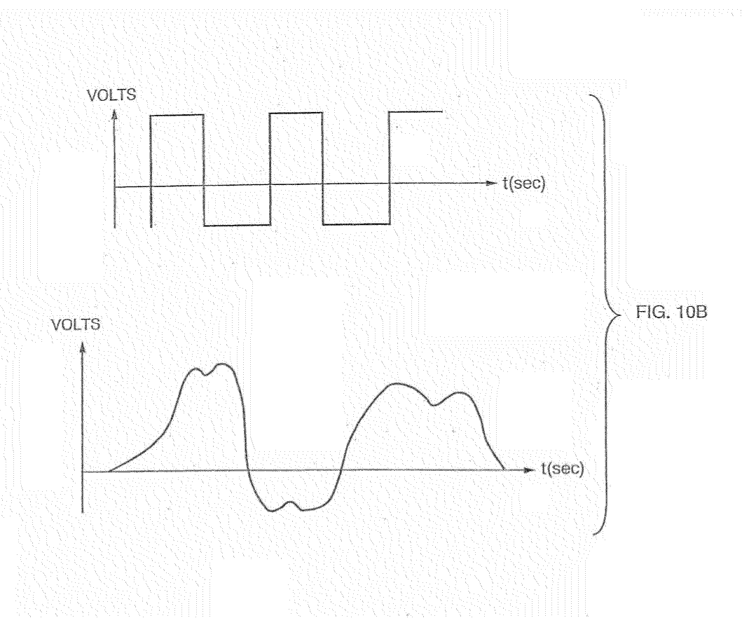

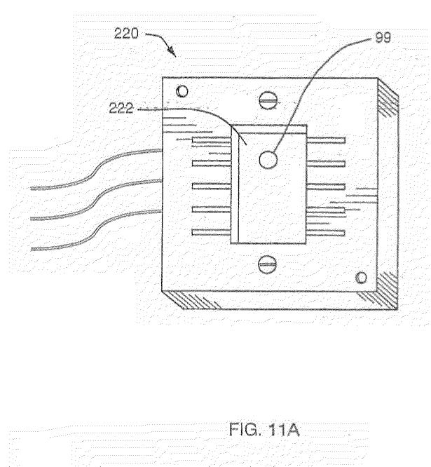

In an illustrative embodiment of applicants' teachings, shown in FIG. 10A, controller 10D includes several subsystems, including an electrospray control 10D1, a waveform generator (synthesizer) 10D2 cooperating with high voltage RF waveform & DC generator 10D3 for applying the RF asymmetric drive signal and DC control bias to filter electrodes 44, 46, and detection electronics 10D4 for detection of ions on the detector electrodes. Computer 10D5 collects data and controls the system. In one embodiment, the RF field is produced in generator 10D3 by a soft-switched semi-resonant circuit that incorporates a flyback transformer to rapidly generate the high voltage pulses. The circuit provides a peak-to-peak RF voltage of at least 1400 volts at a frequency of around 100 KHz-4 MHz with a duty cycle of about 10-70%. Sample RF waveforms for driving the filter electrodes are shown in FIG. 10B, although variations thereof are also within practice of applicants' teachings.

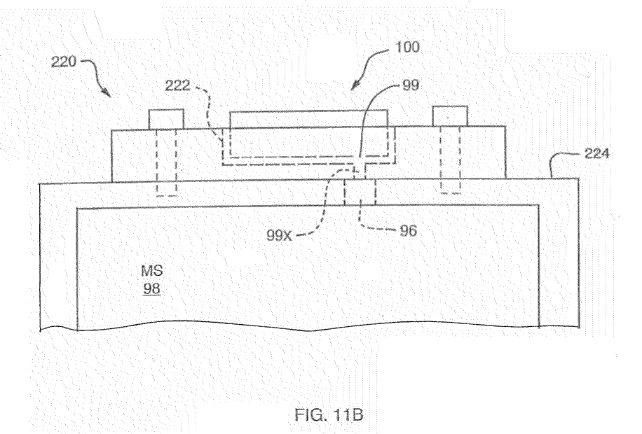

Preferably the chip 100 is inserted into a chip receiver assembly 220. Assembly 220 includes a socket 222 for receipt of the chip. The socket is electrically connected to the controller 10D. A preferred embodiment of chip receiver 220 serves a further function of coupling the chemical sensor system 10 to a mass spectrometer MS 98, as shown in FIG. 11B. Chip receiver assembly 220 is affixed to the face 224 of the mass spectrometer, such that outlet orifice 99 of system 10 is aligned via orifice 99x with the MS orifice inlet 96, whereby ions 24′ are directed into the MS for detection and analysis.

Detection of ions 24 passing through filter 40 may be made as described above in conjunction with the detector electrodes 70, 72 of FIG. 3A. An alternative embodiment is shown in FIG. 3B where electrode 70 is now used as a deflector electrode to deflect ions 24′ toward intake 96 of mass spectrometer 98. The ions are guided or focused by focusing electrodes 72a, 72b and pass through an orifice 99 in substrate 54′ and through plenum gas chamber 101 via a mounting adapter 102. Providing a low flow rate plenum gas into chamber 101 prevents neutralized sample ions or solvent molecules from entering the mass spectrometer intake 96. Ions that are focused into the mass spectrometer intake are then detected according to standard mass spectrometer procedures. It will be appreciated that the plenum chamber 101 is not shown in FIG. 11B, although it may be beneficially used in this embodiment.

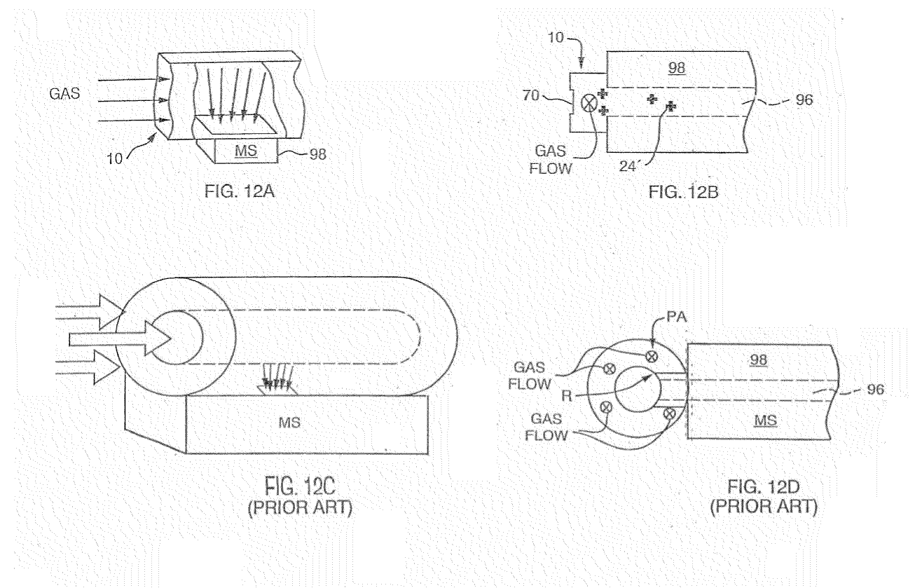

An assembly of applicants' teachings can be easily mounted right up against the mass spectrometer inlet 96 (with or without a plenum chamber), as shown in FIGS. 3B, 11B and 12A-12B, for example. The deflector electrode (side mounting FIG. 3B or 12A-12B) allows almost 100% of ions to be deflected into the mass spectrometer.

This high efficiency is in contrast with the prior art cylindrical design in FIG. 12C-12D, mounted to inlet 96 of the mass spectrometer, where only a small fraction of the total ions in the drift tube are affected by the electric field which propels them into inlet 96 and resulting in only a fraction of the available ions being detected in the prior art.

It will now be appreciated that in practice of applicants' teachings, chemical analysis can be performed using any of several ion detectors. In the embodiments of FIGS. 3A and 4A, the detector is entirely internal to the assembly 10. In the embodiment of FIG. 3B, assembly 10 is intimately mated via adapter 102 to the mass spectrometer 98 as a detector. In the embodiment of FIG. 3B, if the current on focusing electrodes 72a, 72b is monitored, then additional detector information is available for processing the detection information of mass spectrometer 98. Even without focusing electrodes 72a, 72b, a FAIMS spectra of applicants' teachings can be reconstructed by monitoring the total ion current in the mass spectrometer.

Alternative embodiments of applicants' teachings are shown in FIGS. 13A, 13B where the electrospray tip 20 has been inserted within ion region 23, either from above through orifice 31 in upper substrate 52′ (FIG. 13A) or from the side (FIG. 13B). Attractor electrodes 104, 106 attract and guide the ions in the flow path 30 as they travel in gas flow 90 toward filter electrodes 44, 46. In FIG. 13A, droplets from the electrospray tip 20 collect in reservoir 54a, which also may be provided with a drain hole 54b.

It is desirable to concentrate ions after they pass through the ion filter and before entering output section 10C. This improves the signal to noise ratio at the detector and improves sensitivity. An ion trap or ion well can collect ions in this manner, concentrating them and then delivering the concentrated ions at once to the output section. Neutrals are not collected in the ion trap and are continuously being removed by the gas flow from the ion trap T.

An ion trap can be applied to many embodiments of applicants' teachings, such as in FIG. 3A,B,C, for example. An illustrative embodiment is shown in FIG. 13A, where an ion trap T is formed with several appropriately biased electrode pair. In one example, for positive ions, the electrodes are biased such that a potential minimum is formed in the region of electrode pair 76b and potentials on electrode pairs 76a and 76c are higher. Ions are allowed to accumulate in the trap, and after a desired amount of time resulting in collection of a desired number of ions, the trap can be opened by adjusting the voltages applied to electrodes 76a, 76b and 76c. When the trap is opened, the trapped ions 24′ flow into the output section 10C.

In the embodiments discussed above, ion filter 40 includes spaced electrodes 44, 46 which are driven by the RF and DC generator 10D3 as ions are propelled by gas flow 90 in drift tube 29. In the embodiment of FIG. 14A, 14B, a longitudinal electric field driven embodiment of applicants' teachings, a novel method of conveying the ions in the drift tube 29 is shown.

In the embodiments of FIG. 14A, 14B, the ions are propelled toward the output section 10C using a longitudinal electric field generated by electrodes 110 and 112. These embodiments feature a simplified gas flow structure in a very compact design, and gas flow is even optional.

In one embodiment, ions actually travel in an opposite direction to gas flow 122, and are propelled by electric field vector 120. This gas flow opposite to the ion travel direction enhances the desolvation of the sample ions. It also maintains a clean ion filter 40 free of neutral sample molecules. This consequently decreases the level of ion cluster formation resulting in more accurate detection of ion species. Furthermore the counter gas flow clears out and reduces memory effects of previous samples in ionization region 23. This embodiment can include integrated electrospray tip 20 inserted within ion region 23 from above, or side mounted, as are shown.

In the longitudinal electric field driven embodiments of FIG. 14A, 14B, ions 24, 26 are conveyed without gas flow 122 but rather by action of a longitudinal electric field produced by sets of cooperating electrodes 110, 112 along with a longitudinal RF & DC generator 10D3′. As an example of the operation of the PFAIMS in a particular electrode bias scheme, several or all of the electrode pairs 110a-h, 112a-h have the same RF voltage applied, while the DC potentials are stepped so that a longitudinal potential gradient is formed to drive the ions towards the detector. This embodiment can operate without a gas flow or optionally can include an exhaust gas flow 122 which exhausts neutrals and solvent molecules out exhaust port 124.

In one example, electrodes 110, 112a might have 10 vdc applied thereto and electrodes 110h, 112h then might have 100 vdc applied. Now negative ions in region 10A are attracted by electrode pair 110a-112a and further attracted by pair 110h, 112h, and their momentum then carries them into detector region 10C if passed by the filter.

The RF and compensation may be applied to various of the electrodes 110a-h, 112a-h, and will operate in the manner set forth above.

In another embodiment of FIG. 14A the electrospray tip can be external to ionization region 23 (not shown) above orifice 31 where electrode 112j serves as the attraction electrode. In the longitudinal electric field driven embodiment of FIG. 14B, the ion filter includes spaced resistive layers 144,146 insulated from electrodes 134, 136, by insulating medium 140, 142, for example, a low temperature oxide material. Preferably the substrates are insulating. Resistive layers 144, 146 are preferably a ceramic material deposited on insulating layers 140,142. Terminal electrode pairs 150, 152, 154, 156 make contact with a resistive layer and enable a voltage drop across each resistive layer to generate the longitudinal electric field vector 120. Electrodes 150 and 154 are biased according to application, for example they may be at 1000 volts while electrodes 152 and 156 may be at zero volts.

When the embodiment of FIG. 14B is implemented in a cylindrical design, then the electrodes 150 and 154 form a ring electrode, and electrodes 152 and 156 form a ring electrode, and resistive layers 144, 146 form a cylinder.

Applicants' teachings can also demonstrate time of flight ion mobility spectrometry functions. For example, in the embodiment of FIG. 14A, electrodes 104, 106 are pulsed to draw a sample from tip 20 that is ionized, starting the time cycle. Electrodes 110a-h, 112a-h are biased relative to their neighbors so that the ions are driven by the generated longitudinal electric field gradient towards output section 10C. A counter gas flow 122 can be applied to sweep sample neutrals away. A combination of these electrodes can be used to form the ion trap T described above (see FIG. 13A).

In the split gas flow embodiment of FIG. 15A, the electrospray needle 12 is inserted through substrate 52 and into ion region 23, however, it may be mounted externally to the drift tube such as in FIG. 3A. The ion flow generator in this design includes a plurality of segmented electrodes 160, 162 on opposite sides of flow path 30 to create longitudinal electric field E. In the preferred embodiment, one or more discrete electrodes 160′, 162′ are located downstream of gas inlet 170 to extend longitudinal electric field E beyond the split flow of gas, and thereby ensuring that ions flow into filter 40 as carried by drift gas flow stream 172.

In the embodiment of FIG. 15B, mass spectrometer 98 is directly coupled to the end of the drift tube 30. An advantage of this design is that the ion filter 40 is kept free of sample neutrals by virtue of the split gas flow. This prevents clustering of neutral sample molecules with ions, and this results in higher detection accuracy. A venting device 103 for venting of neutrals N keeps neutrals out of the MS intake.

A baffle 174 may be placed as shown to regulate the velocity of waste gas flow stream 176 relative to the velocity of drift gas flow stream 172. Typically, drift gas flow stream 172 is at a higher velocity than waste gas flow stream 176. Other means for creating a waste gas flow stream of a velocity different than the drift gas flow stream, however, are within the scope of applicants' teachings.

In the embodiments of FIG. 15A, 15B, various sample preparation sections can be used, whether simple a port to draw in ambient air samples, or electrospray, gas chromatograph, liquid chromatograph, or the like. Regardless of what is used, the split gas embodiment shown can prevent clustering and allows better identification of ion species.

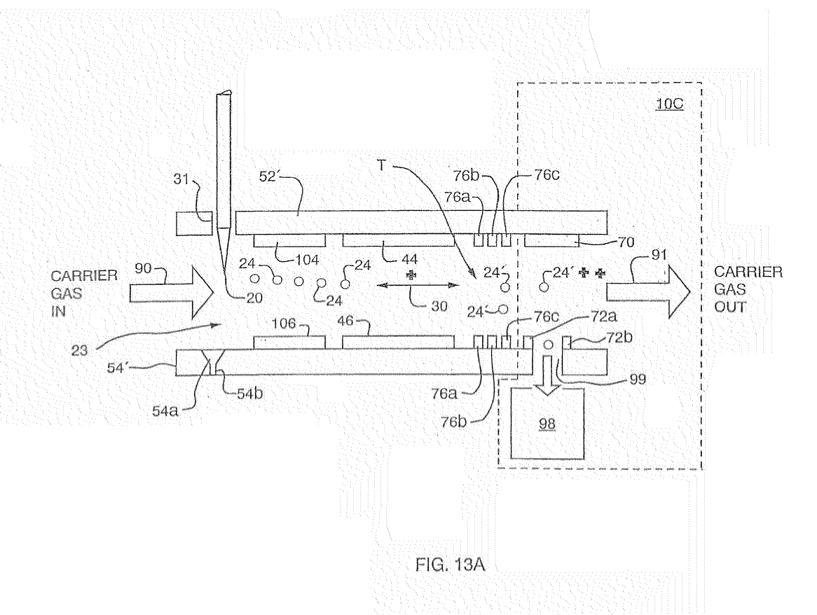

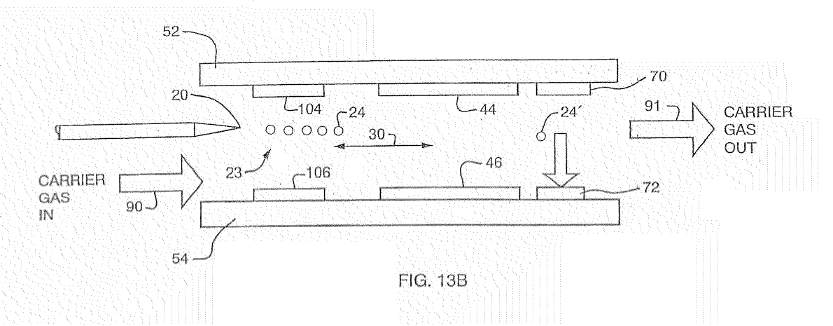

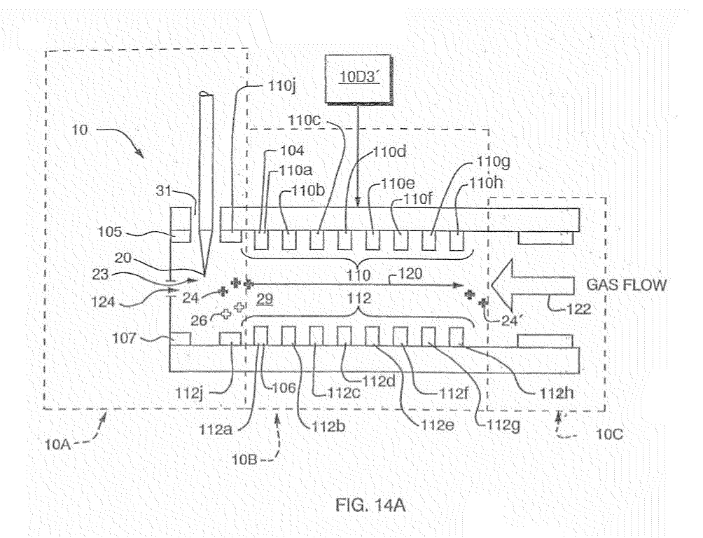

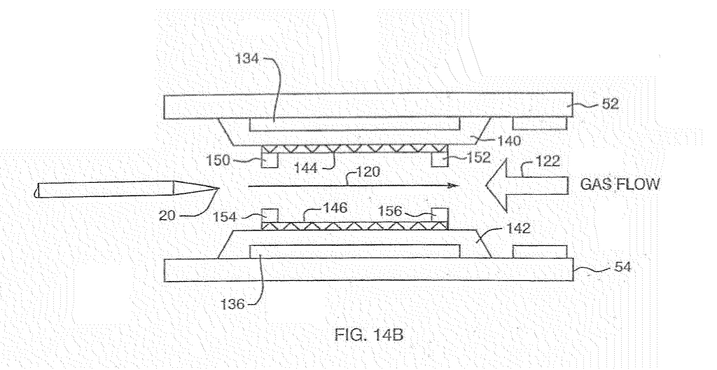

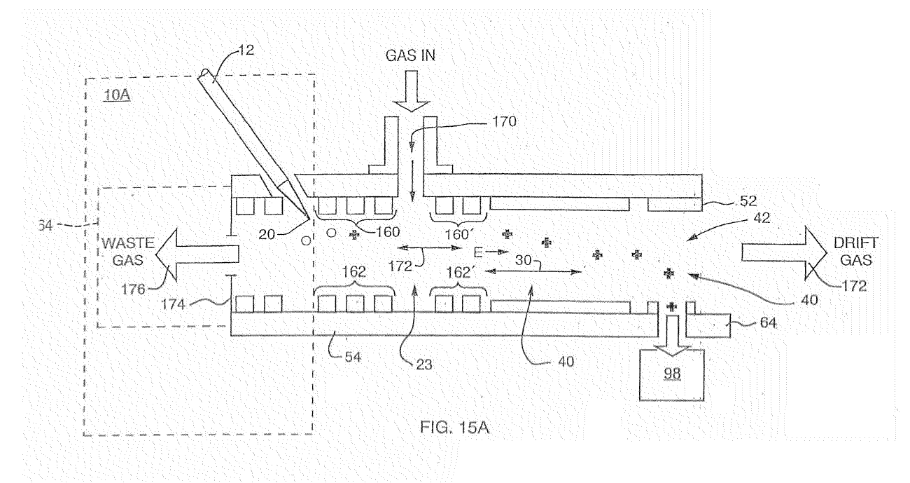

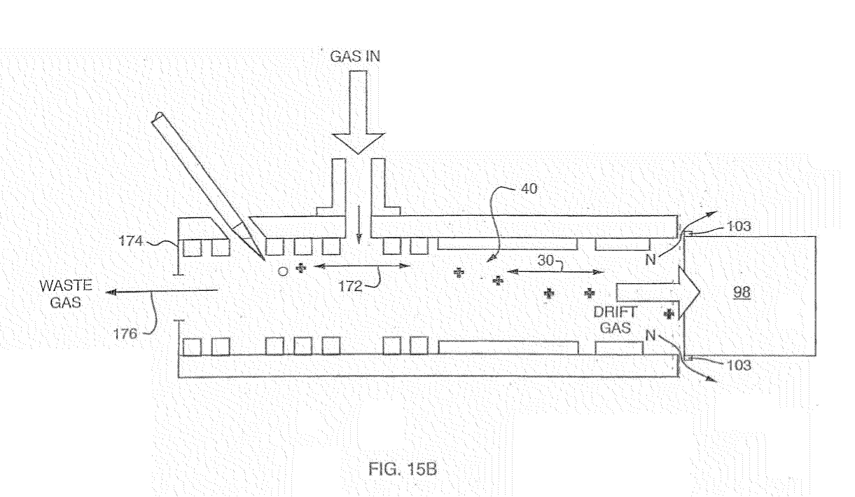

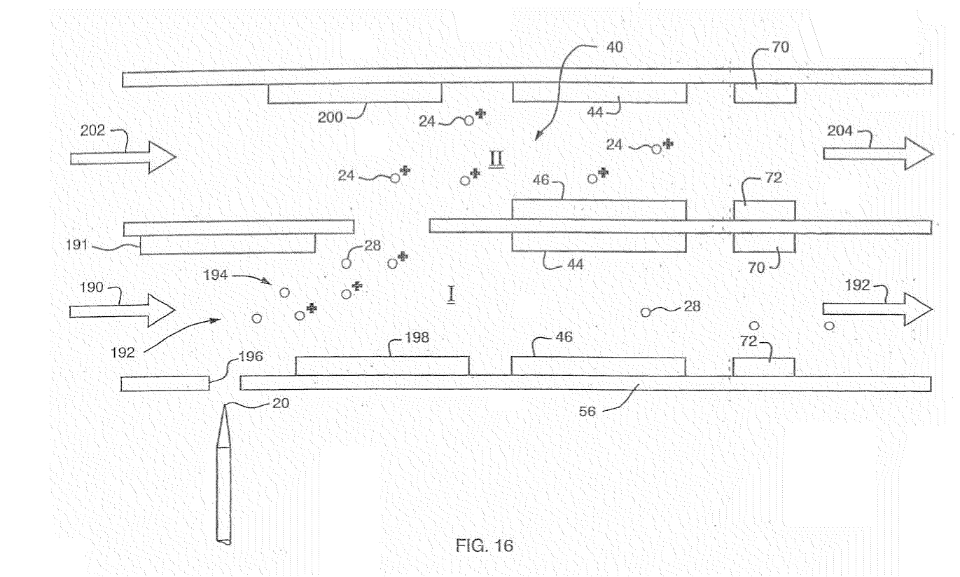

Generally the sample ions tend to be found in monomer or cluster states. The relationship between the amount of monomer and cluster ions for a given ion species is dependent of the concentration of sample and the particular experimental conditions (e.g., moisture, temperature, flow rate, intensity of RF-electric field). Both the monomer and cluster states provide useful information for chemical identification. It will be useful to investigate the same sample separately in a condition which promotes clustering, and in an environment that promotes the formation of only the monomer ions. A planar two channel PFAIMS of an embodiment such as shown in FIG. 16 can be used to achieve this.

In the dual channel embodiment of FIG. 16, a first channel “I” is shown for receipt of ions 24, and molecules 28 in a drift gas flow 190 in ion region 194. Also included are PFAIMS filter electrodes 44, 46 and detector electrodes 70, 72.

To interrogate the sample ions in the monomer state, the ions are extracted from the flow stream (by action of an electric field between electrodes 198 and 200) and they flow up into upper chamber “II”. The neutral molecules 28, typically solvent, continue to flow through channel “I” and exit at drift gas exhaust 192. The potential difference between the electrospray tip 20 and the attraction electrode 191 accelerates the ions into the ion region 194 through orifice 196 in substrate 56. A second gas flow 202 prevents the sample neutrals from entering chamber “II” and carries ions 24 to PFAIMS filter 40 (electrodes 44, 46 in Chamber II), and the passed ions are then detected, such as with detector electrodes 70, 72 as in FIG. 3A or with a mass spectrometer as in FIG. 3B. The second gas flow 202 exhausts as flow 204. When the deflection and attractor electrodes 198, 200 are not energized, then the sample ions can be observed in the cluster state in chamber “I” by the local detector electrodes 72 and 70. By alternatively energizing and not energizing electrodes 198 and 200 significantly more information can be obtained to better identify the chemical sample.

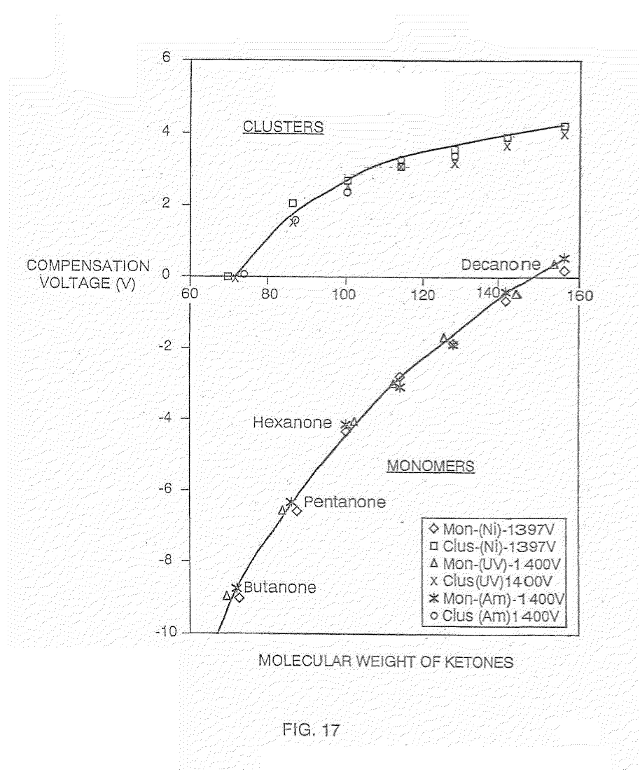

FIG. 17 shows a homologous series of Ketone samples obtained in one practice of applicants' teachings, ranging from Butanone to Decanone. From the figure it is evident that for the same chemical species the cluster ions (top plot) require very different compensation signals compared to the monomer ions (bottom plot). So by observing the difference in peak position of the monomer and cluster peak the level of identification of the chemical compound can be significantly increased. For example, for Butanone the peak position in the monomer state occurs close to −9 volts while the cluster peak is around zero. For Decanone for example, the monomer peak is close to zero while the cluster peak is at around +4 volts.

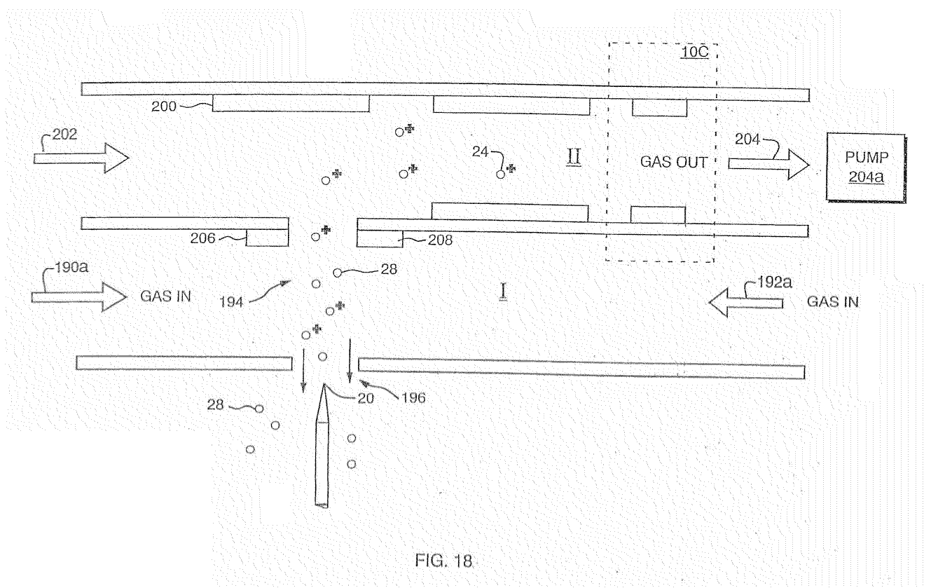

The motivation for the embodiment shown in FIG. 18 is the same as that of embodiment 16. In this system switching between a monomer state and cluster state operating condition is achieved by control of a curtain gas flow 190a and 192a. With the curtain gas applied, sample neutrals 28 are prevented from entering channel “II” and ions in the monomer state can be investigated. Curtain gases 190a and 192a may flow in the same direction and exhaust at orifice 196 for example. Meanwhile the gas flows in channel “II” remain in the same configuration as the system in FIG. 16 Guiding electrodes 206 and 208 are included to guide the ions into channel “II”. Attraction electrode 200 is also used to attract ions into channel “II”. When the curtain gas is turned off, ions in the cluster state may be observed since sample neutrals and sample ions may now be drawn into channel “II” using a pump 204a. Gas flows 202 and 204 may also be used. The output section may be connected to a mass spectrometer.

In application of applicants' teachings, the high field asymmetric ion mobility filtering technique uses high frequency high voltage waveforms. The fields are applied perpendicular to ion transport, favoring a planar configuration. This preferred planar configuration allows drift tubes to be fabricated inexpensively with small dimensions, preferably by micromachining. Also, electronics can be miniaturized, and total estimated power can be as low as 4 Watts (unheated) or lower, a level that is suitable for field instrumentation.

We have described novel apparatus that combines electrospray and filtering components. We further disclose micromachined PFAIMS-electrospray interface chips. The PFAIMS-electrospray interface chips offer unique benefits compared to all prior bio-molecule-filtering methods for electrospray mass spectrometry. At the same time this approach can be used in conjunction with many in-liquid separation techniques such as capillary electrophoresis.

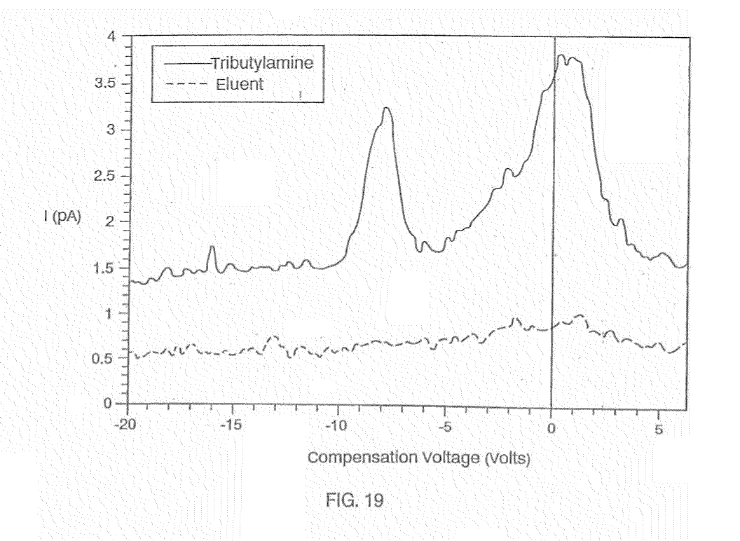

In practice of an embodiment of applicants' teachings, tributylamine was electrosprayed into the PFAIMS filter and detector. Resulting spectra are shown in FIG. 19 for the amine in solvent and for the solvent eluent alone. There is virtually no response for the eluent alone, and significant response to the amine. This demonstrates practical value and function of applicants' teachings.

Applicants' teachings provide improved chemical analysis in a compact and low cost package. Applicants' teachings overcome cost, size or performance limitations of prior art TOF-IMS and FAIMS devices, in novel method and apparatus for chemical species discrimination based on ion mobility in a compact, fieldable package. As a result a novel planar, high field asymmetric ion mobility spectrometer device can be intimately coupled with a electrospray tip to achieve a new class of chemical sensor, i.e., either as a standalone device or coupled to an MS. A fieldable, integrated, PFAIMS chemical sensor can be provided that can rapidly produce accurate, real-time or near real-time, in-situ, orthogonal data for identification of a wide range of chemical compounds. These sensors have the further ability to render simultaneous detection of a broad range of species, and have the capability of simultaneous detection of both positive and negative ions in a sample. Still further surprising is that this can be achieved in a cost-effective, compact, volume-manufacturable package that can operate in the field with low power requirements and yet it is able to generate orthogonal data that can fully identify various a detected species.

Another advantage of the PFAIMS design over prior art cylindrical designs is the ability of the PFAIMS to filter and act on all types of ions with different alpha a dependencies on electric field strength (see background section for more detail on alpha α). This fact allows significant reduction in the complexity of performing measurements in unknown complex sample mixtures.

It will be appreciated by a person skilled in the art that in the prior art cylindrical design shown in FIG. 12C-D, the radial electric field distribution is non-uniform. Meanwhile, in practice of applicants' teachings, such as the PFAIMS shown in FIG. 3A,B, the field distribution between the ion filter electrodes (neglecting fringing fields) in the PFAIMS design is uniform and the field is uniform.

It has been found that the time for separation of ions in the planar FAIMS design is significantly less (˜10 times) than in the prior art cylindrical FAIMS design when reaching conditions for ion focusing.

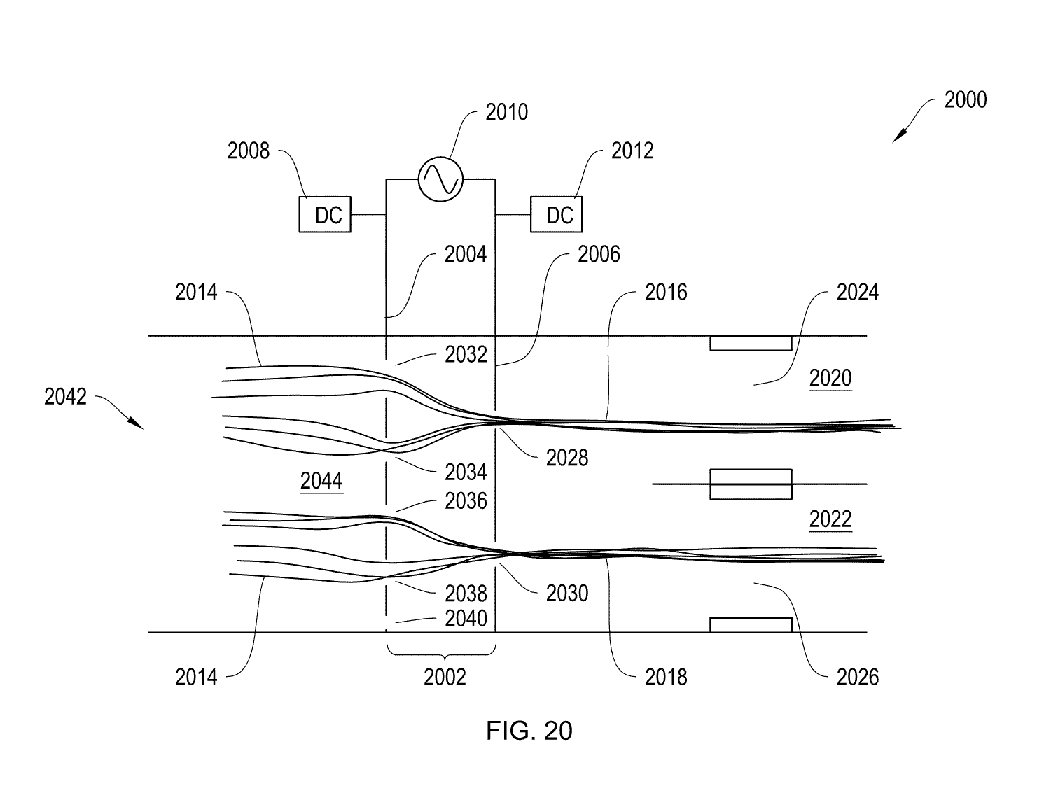

FIG. 20 shows an ion mobility based analyzer system 2000 including an ion focusing assembly 2002 according to an illustrative embodiment of applicants' teachings. An ion mobility based analyzer may include an IMS, DMS, FAIMS (as described above) and/or an ion filter/separator based on ion mobility characteristics. The system 2000 may include an ion inlet 2042, a first grid 2004, a second grid 2006, a first DC source 2008, a second DC source 2012, a time-varying voltage source 2010. The grid 2004 may include a plurality of openings 2032, 2034, 2036, 2038, and 2040 through which one or more ions may flow. The grid 2006 may include one or more openings 2028 and 2030 through which ions may flow. In one embodiment, the system 2000 includes a first filter channel 2020 and second filter channel 2022. The first filter channel 2020 may include a DMS filter 2024. The second filter channel 2022 may include a second DMS filter 2026. Alternatively, the filters 2024 and 2026 may include other types of filters such as, without limitation, an IMS and FAIMS.

In operation, ions are received at the ion inlet 2042 and travel longitudinally along the flow path 2044 via various ion paths 2014. Each of the ions pass through the first grid 2004 via an opening 2032, 2034, 2036, 2038, and 2040. In one embodiment, a DC bias voltage is applied to grid 2004 while another DC bias is applied to grid 2006. The DC bias voltage may include a ground or reference voltage, a positive voltage, or negative voltage. In certain embodiments, a time-varying voltage, e.g., asymmetric voltage, is applied across the grids 2004 and 2006 to generate a time-varying electrical field between the grids 2004 and 2006. Also, a difference in DC potential between grids 2004 and 2006 can generate a DC electrical field between the grids 2004 and 2006. The time-varying field and/or DC field between the grids 2004 and 2006 may cause the ion paths 2014 to converge and/or narrow at, for example, openings 2028 and 2030 which results in one or more narrowly focused ion streams 2016 and 2018.

In one embodiment, the first filter channel 2020 is aligned such that the ion stream 2016 is directed in a more focused manner through the filter 2024. Also, the second filter channel 2022 may be aligned such that the ion stream 2018 is directed in a more focused manner through the filter 2026. In certain embodiments, at least one of the ion filters 2024 and 2026 may selectively allow certain ion species to pass through to a detector for detection of the ions. The detector may include an electrode, electrodes, a nano-tube, semi-conductive element, a MS, and/or any other type of ion detection component.

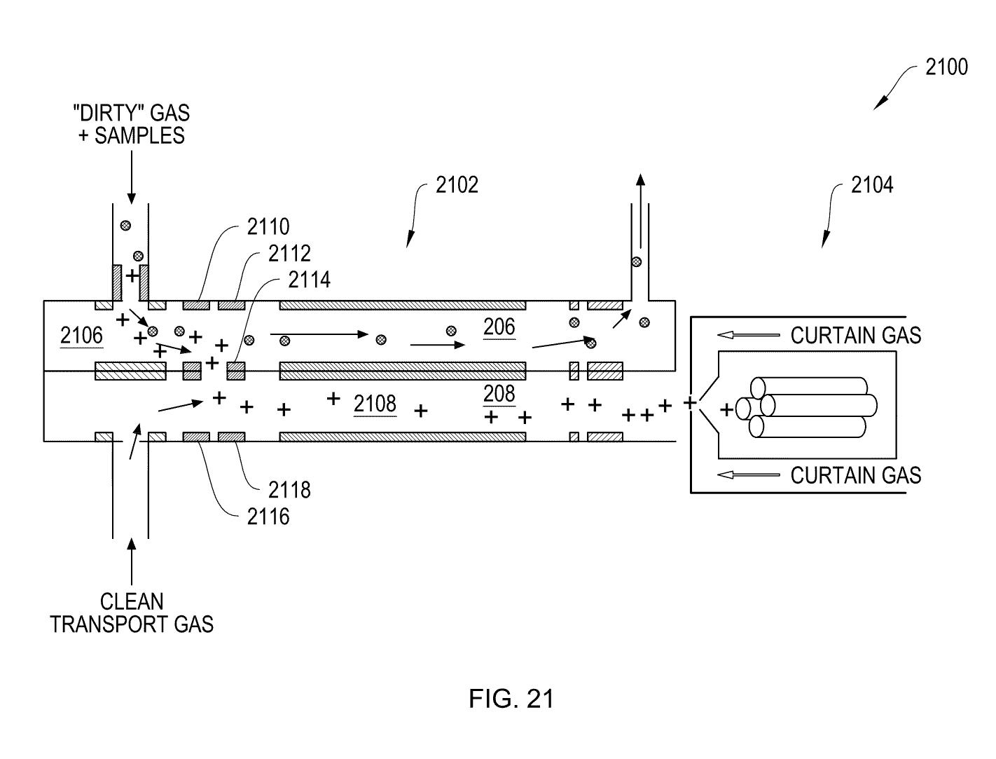

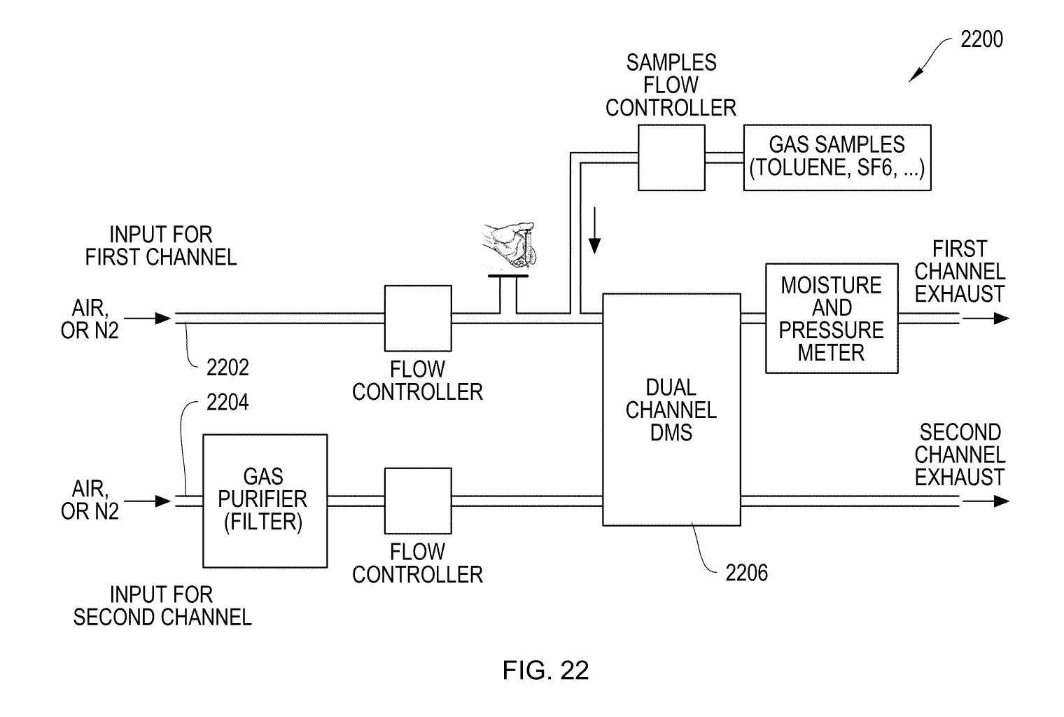

FIG. 21 is a sample analysis system 2100 including a dual channel DMS 2102 as a pre-filter to a mass spectrometer 2104. The system 2100 includes a first channel 2106 having a DMS through which a dirty gas including sample ions passes. The system 2100 also includes a second channel 2108 through which ions of a selected bias (e.g., positive or negative) are passed through a DMS filter within a clean transport gas. Advantages of isolating the ionization region from the separation region include control of clusterization in the second channel, possibility of using two different dopants in ionization and separation areas, enhanced sensitivity due to removed membrane. Additionally the configuration allows for independent conditions for formation and separation of sample ions, e.g., independent optimization flow rates in the ion source and in the analytical gap. Other advantages include a decreased effect of external moisture on second channel spectra, and ability to use a modifier gas (e.g. helium) to improve separation in the DMS and MS.

In one embodiment, the system 2100 includes an ion control assembly having, for example, electrodes 2110, 2112, 2114, 2116, and 2118. In one instance, electrodes 2110 and/or 2112 may operate as a deflector electrode (having positive bias) such that it directs positive ions toward an opening into the second channel 2108. Electrodes 2114, 2116 and 2118 may be biased negatively to, for example, attract positive ions into the second channel.

In one embodiment, positive ions are directed into the second channel 2108 for DMS filtering and then for MS 2104 analysis by MS 2104. The negative ions within the first channel 2106 may also be filtered by a DMS filter and detected using detector electrodes. In another embodiment, negative ions are directed into the second channel 2108 while positive ions remain within the first channel 2106. Thus, the negative ions may be filtered by the DMS in the second channel 2108 and then analyzed by the MS 2104, while the positive ions are filtered by the DMS in the first channel 2106 and detected using detector electrodes in the first channel 2106.

By using a DMS as a pre-filter to a MS the information available for chemical identification is enhanced, which is especially valuable for isobaric species including stereoisomers. Additionally the DMS pre-filter reduces chemical noise by a factor of 10-30, thereby enhancing the detection limit an quantitation accuracy. For complex mixtures, DMS pre-separation can replace or reduce the requirement and time for separation steps in GC or HPLC. Additionally, adding a DMS pre-filter is valuable for miniature mass spectrometers because it restores the lost analytical capability and can provide the same quality of analysis as an expensive lab MS system.

FIG. 22 shows a functional block diagram of a dual channel system 2200 utilizing a dual channel DMS 2206, such as in system 2100, according to an illustrative embodiment of applicants' teachings. The system 2200 shows a sample input for a first channel 2202 and a second channel 2204 receiving purified gas. The sample input may include an electrospray, liquid, and/or gas sample input including gas samples such as, without limitation, toluene and SF6.

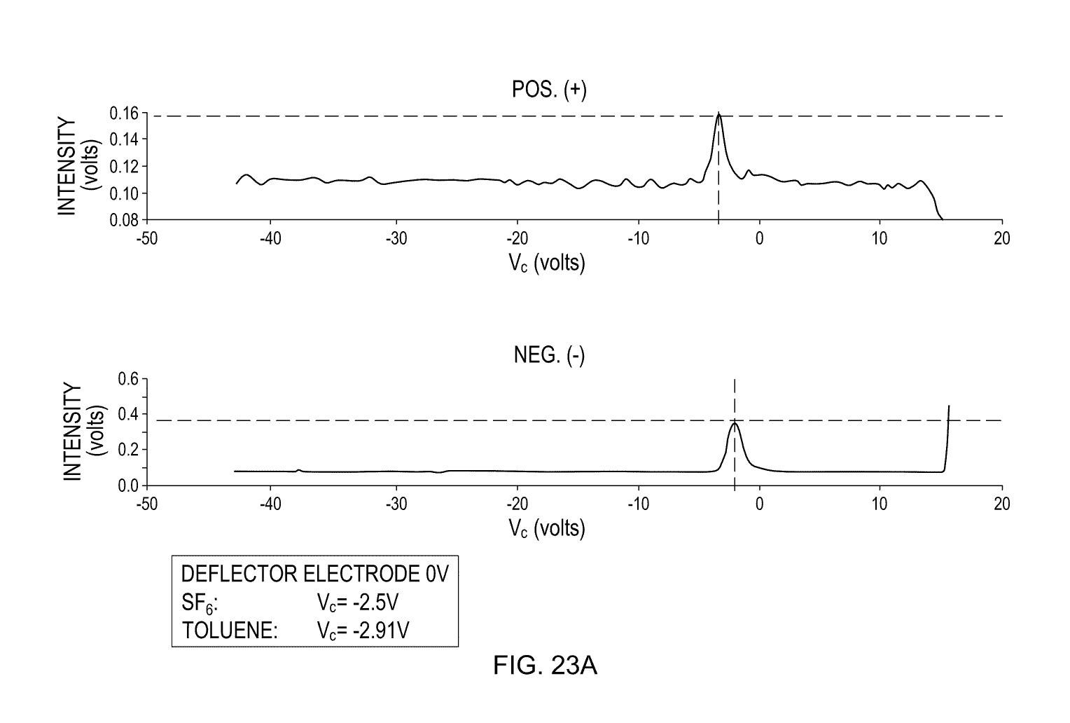

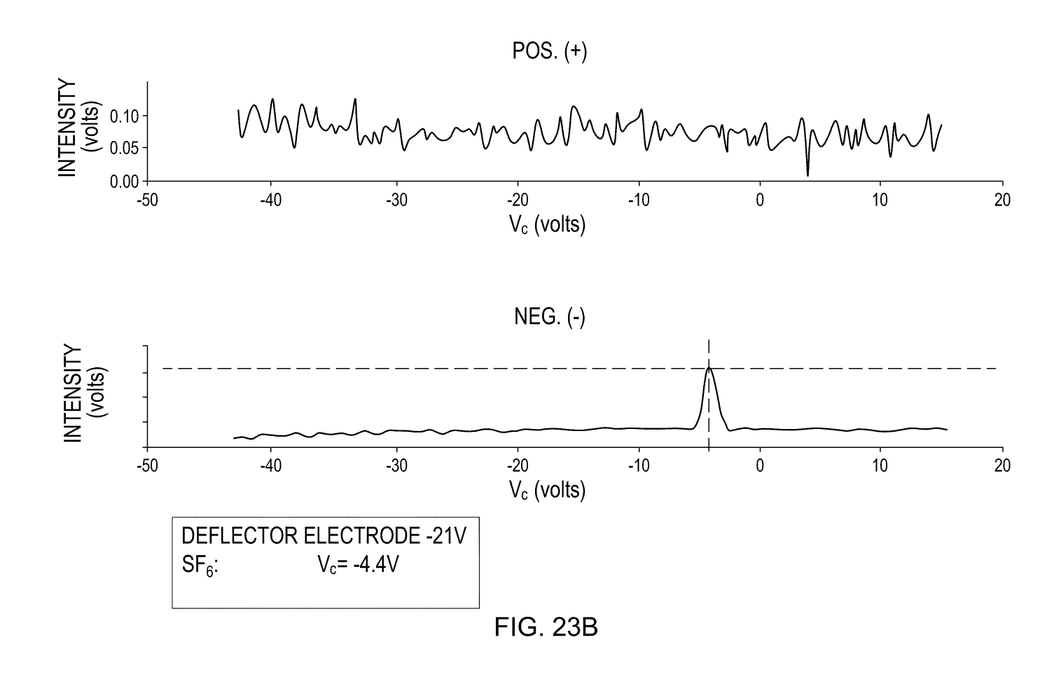

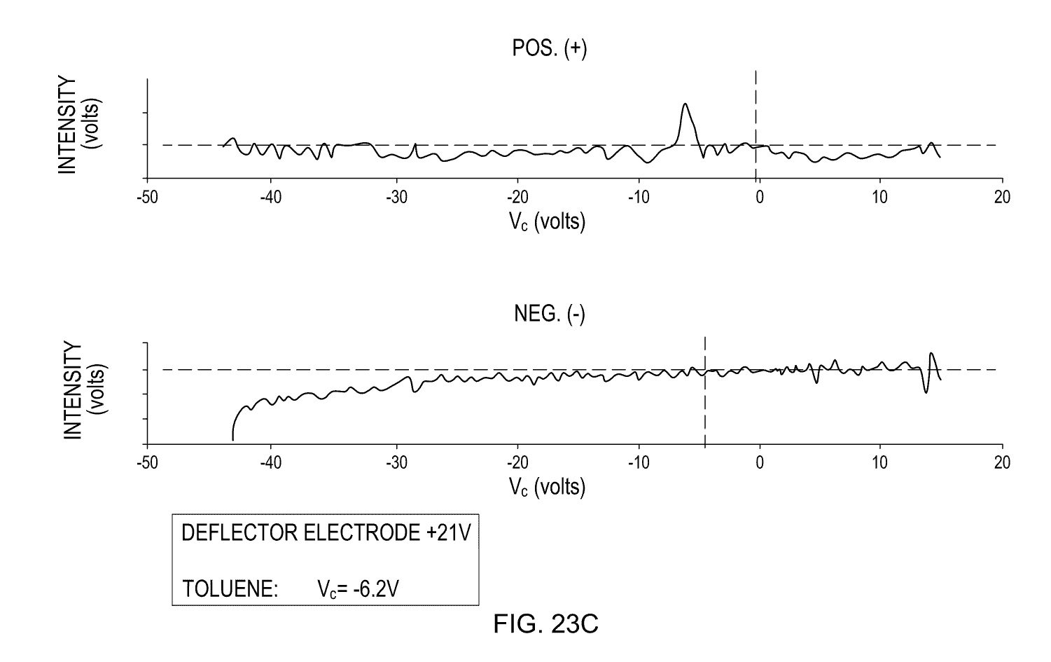

FIGS. 23A-23C show plots of ion intensity vs. compensation voltage (of the DMS filters) within the first channel 2106 and second channel 2108 depending on whether positive or negative ions are deflected into the second channel according to an illustrative embodiment of applicants' teachings. FIG. 23A shows the ion intensity spectrum (vs. Vc) when the bias of electrodes 2110 and 2112 is set to 0 volts, i.e., when no ions are deflected from the first channel 2106 into the second channel 2108. The plot of FIG. 23A shows ion intensity peaks detected by both the positive and negative detector electrodes in the first channel 2106. FIG. 23B shows a negative ion detection peak when the deflector electrodes 2110 and/or 2112 are biased at −21 volts, indicating that negative ions where deflected into the second channel 2108 and detected (by either the MS 2104 or detector electrodes). FIG. 23C shows a positive ion detection peak when the deflector electrodes 2110 and/or 2112 are biased at +21 volts, indicating that positive ions where deflected into the second channel 2108 and detected (by either the MS 2104 or detector electrodes).

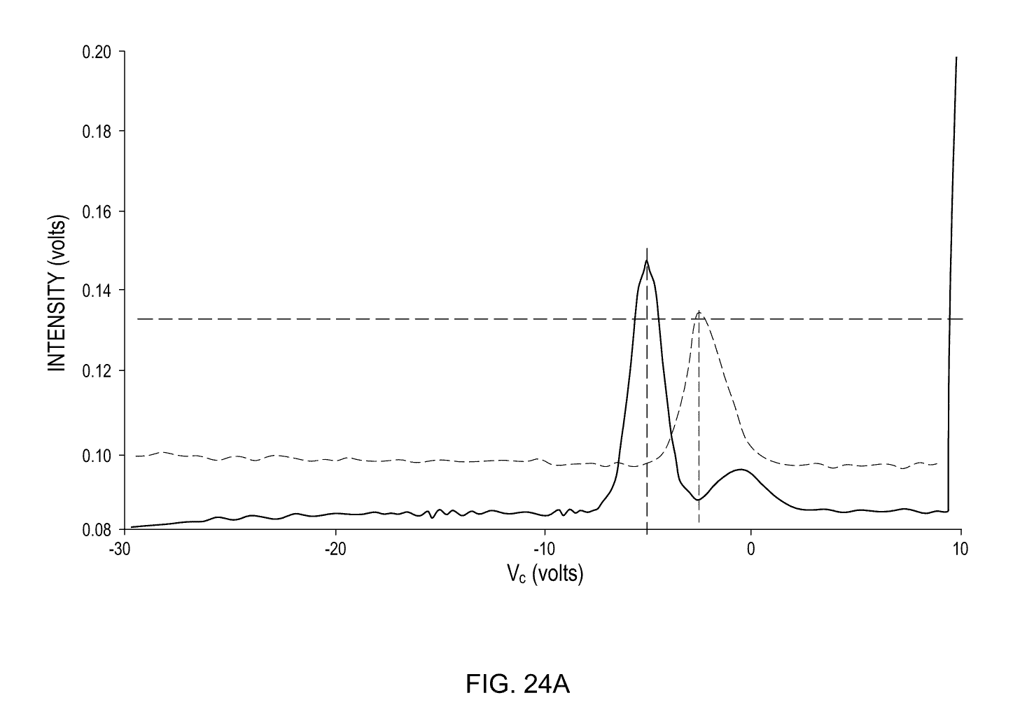

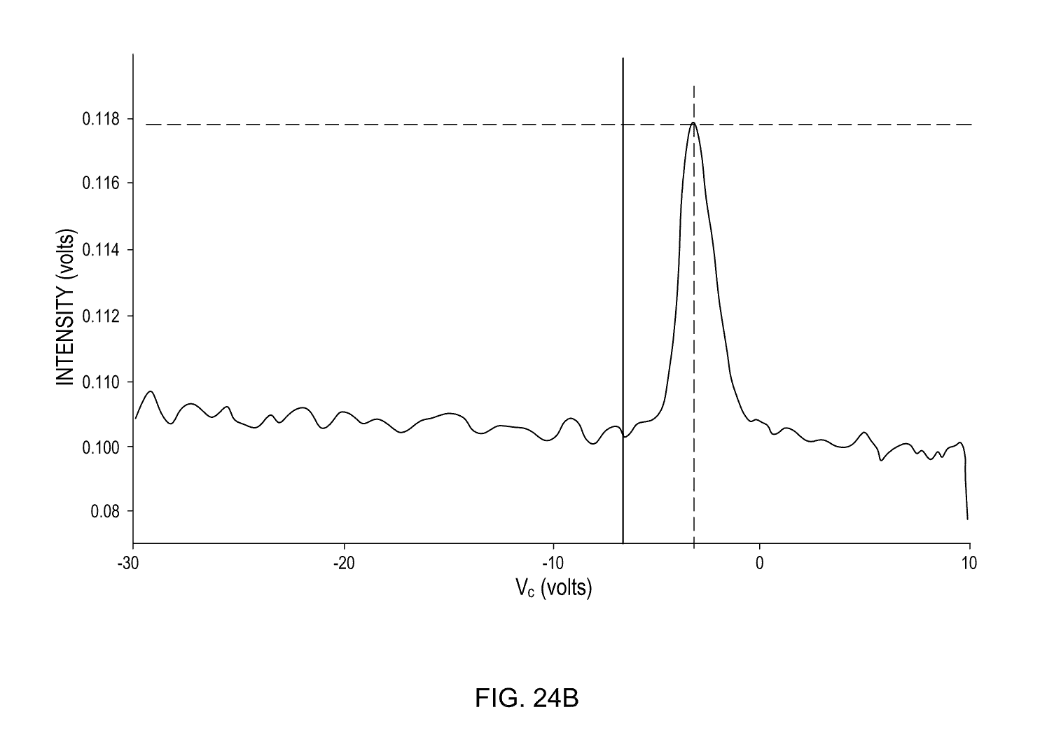

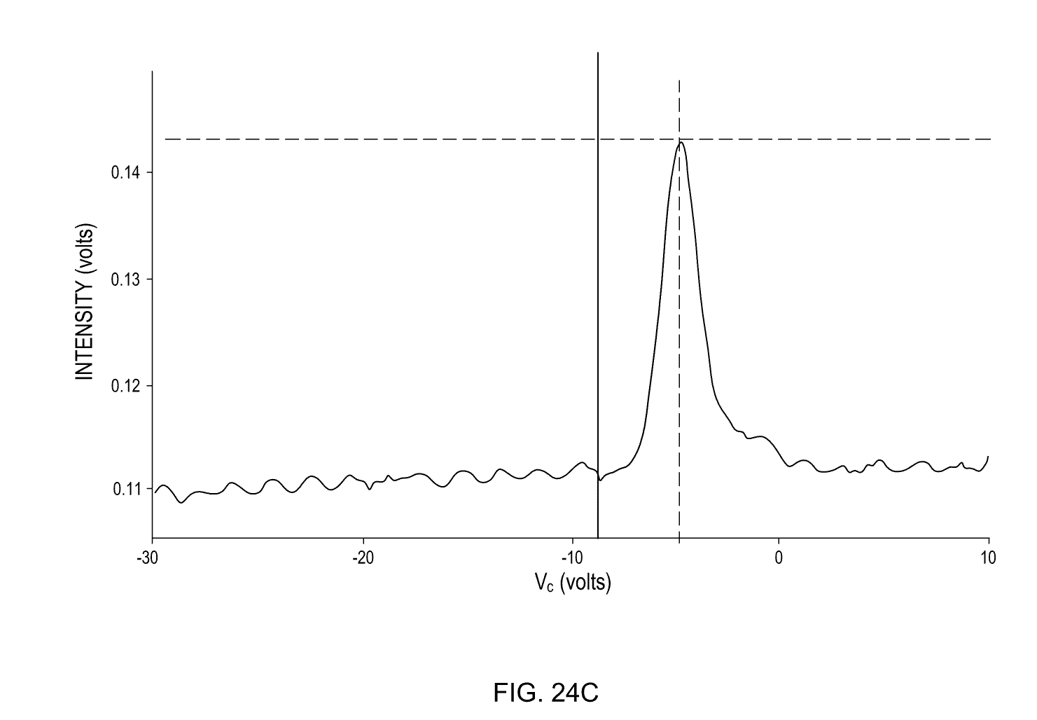

FIGS. 24A-24C illustrate the coefficient of transfer from the first channel 2106 to the second channel 2108 for Toluene and SF6 when the deflector electrodes are bias positively and negatively respectively. FIG. 24A shows the positive and negative ion intensity peaks detected at the detector electrodes of the first channel 2106. FIG. 24B shows the positive ion intensity peak associated with Toluene in the second channel 2108 when positive ions are deflected into the second channel 2108. FIG. 24C shows the negative ion intensity peak associated with SF6 in the second channel 2108 when negative ions are deflected into the second channel 2108.

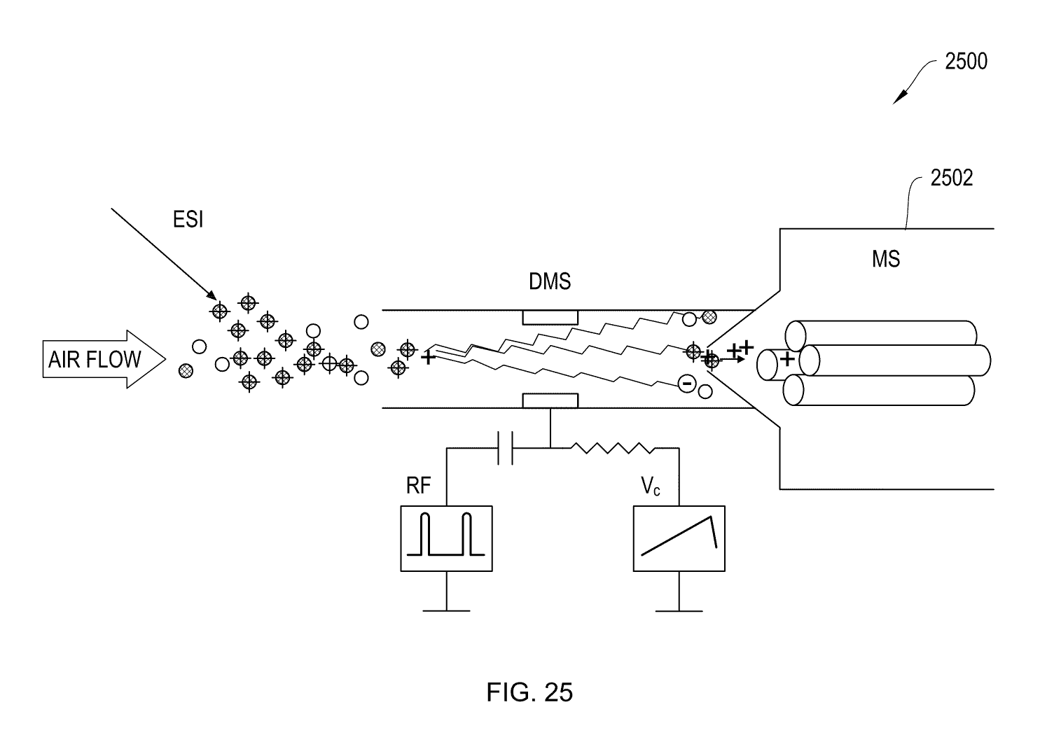

FIG. 25 shows a typical prior art DMS-MS system 2500 utilizing high flow consumption in the MS 2502. Due to the relatively high flow rate supported by the MS 2502, a powerful vacuum pumping system is needed to maintain an adequate vacuum in the MS 2502 for analysis of ions in a vacuum. For many applications, such as in a laboratory environment, the need for powerful, large, and heavy pumps in not a concern. However, for field-deployable and portable devices, the size, weight, and power consumption of a DMS-MS system is critical.

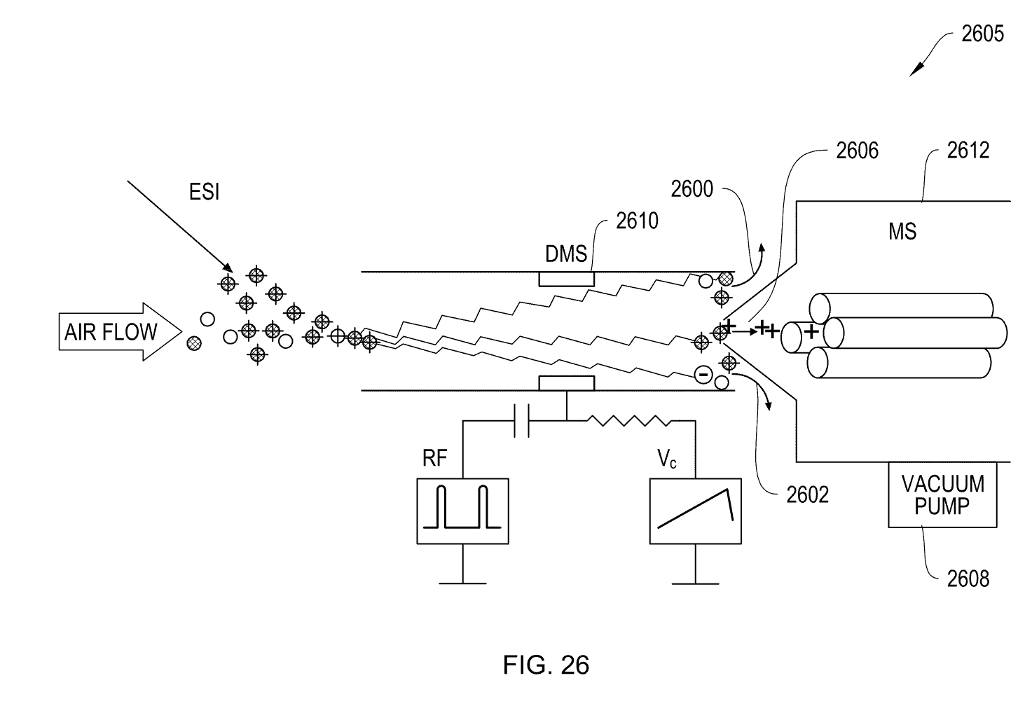

FIG. 26 shows DMS-MS system 2605 including a DMS pre-filter 2610 supporting low flow rate Atmospheric Pressure Interface (API) for an MS 2612 according to an illustrative embodiment of applicants' teachings. In contrast to the DMS-MS system of FIG. 25, the DMS-MS system of FIG. 26 directs a portion of the DMS flow 2600 and 2602 through exhausts while another, lower flow rate portion of flow 2606, is directed into the MS 2612. By reducing the input flow rate requirement into the MS 2612, the size and power of the vacuum pump 2608 for the MS 2612 can be reduced and, thereby, enable an overall reduction in the size of the DMS-MS system 2605.

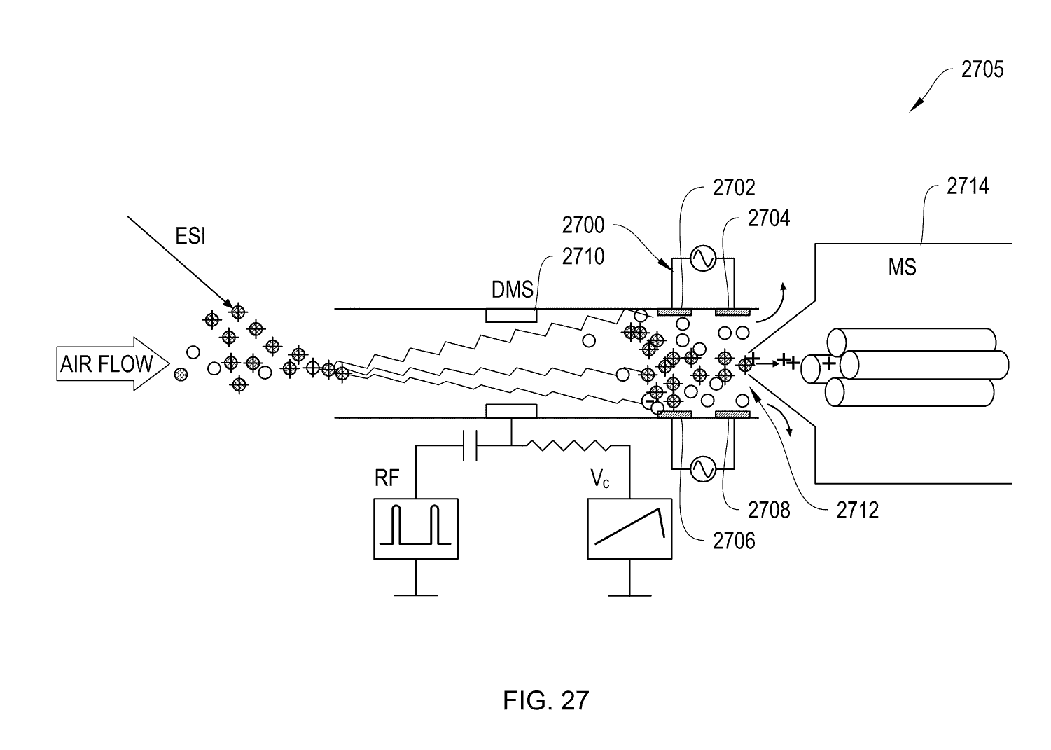

FIG. 27 shows another DMS-MS system 2705 including an ion focusing element 2700 according to an illustrative embodiment of applicants' teachings. The operation of the ion focusing element 2700 is described in further detail with respect to the ion focusing assembly 2002 of FIG. 20. In certain embodiments, the ion focusing element 2700 includes electrodes such as electrodes 2702, 2704, 2706, and 2708. In other embodiments, the ion focusing element 2700 includes grids such as grids 2004 and 2006 of FIG. 20. In operation, the ion focusing element 2700 receives DMS-filtered ions from a DMS 2710, focuses the ions into a narrow ion stream along a longitudinal axis corresponding to the orifice 2712 of an MS 2714. By focusing the desired ions into the orifice 2712, the size of the orifice 2712 can be significantly reduced while allowing the same or greater amount of ions into the MS 2714. Typical MS orifices have a diameter of 100 microns or greater. By focusing the ion using the ion focusing element 2700, the orifice diameter can be reduced to less than about 100 microns, less than about 75 microns, less than about 50 microns, less than about 25 microns, less than about 20 microns, less than about 10 microns and less than about 5 microns. Thus, by enabling a significantly smaller orifice 2712, the ion focusing enables a significantly lower flow rate into the MS 2714, resulting in a significantly smaller and less powerful vacuum/flow pump, and more compact DMS-MS system.

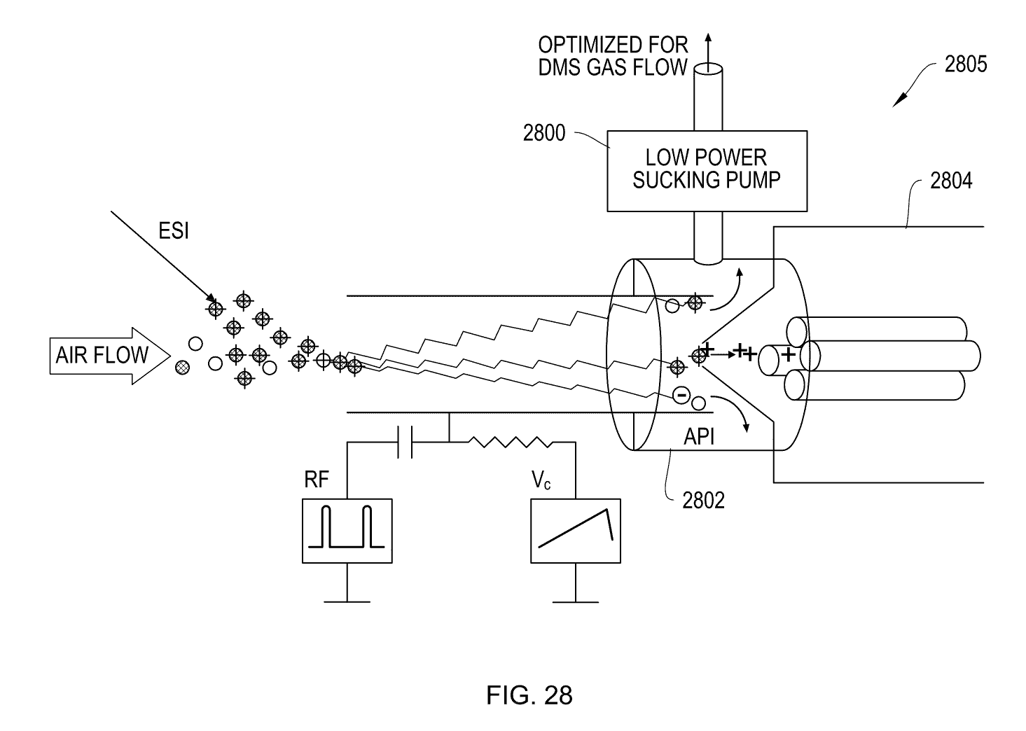

FIG. 28 shows another DMS-MS system 2805 including a low power sucking pump 2800 according to an illustrative embodiment of applicants' teachings. The DMS-MS system 2805 may include an ion focusing element such as element 2700 of FIG. 27. The pump 2800 may be optimized for DMS gas flow to enable low flow rate into the MS 2804 via the API 2802. In certain embodiments, the MS 2804 may include a separate vacuum pump, vacuum pumps, and/or vacuum control system other than the low power sucking pump 2800.

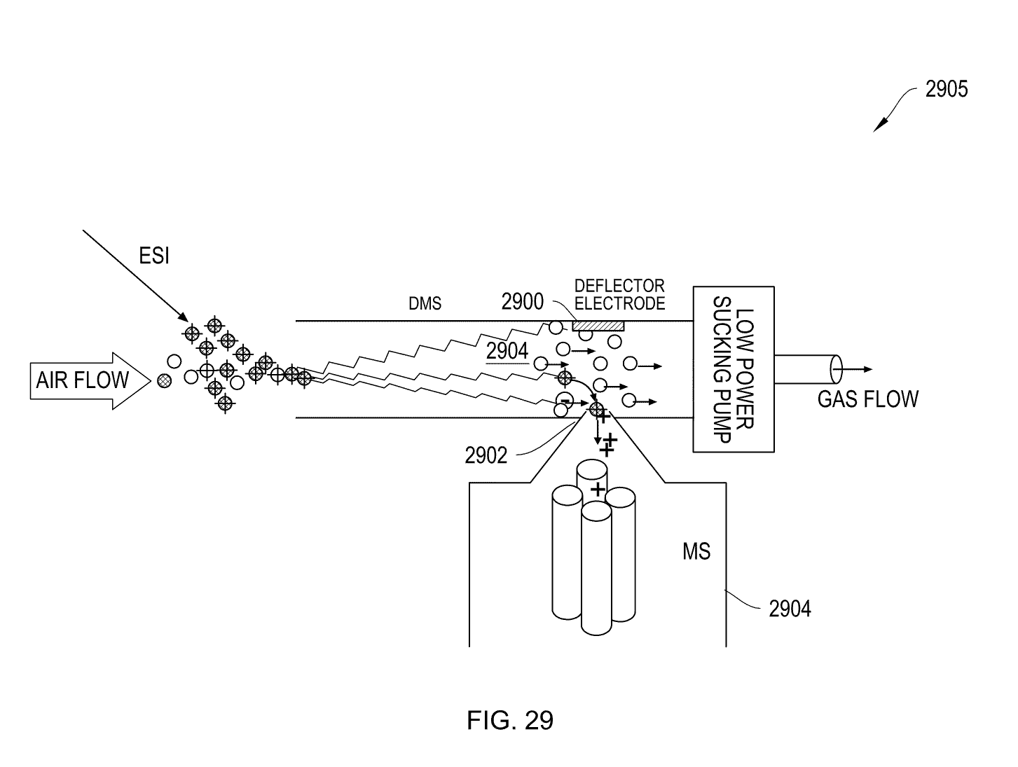

FIG. 29 shows yet another DMS-MS system 2905 including an MS interface and orifice 2902 positioned out of line (e.g., at a right angle) from the DMS flow 2904. A deflector electrode 2900 is employed to deflect DMS filtered ions toward the orifice 2902 of the MS 2904. In certain embodiments, the orifice diameter is relatively small, such as described with respect to FIG. 27, so that the linear velocity is relatively high through the orifice 2902. Thus, ions are able to overcome the electric field effect which would prevent ions from flowing into the MS 2904.

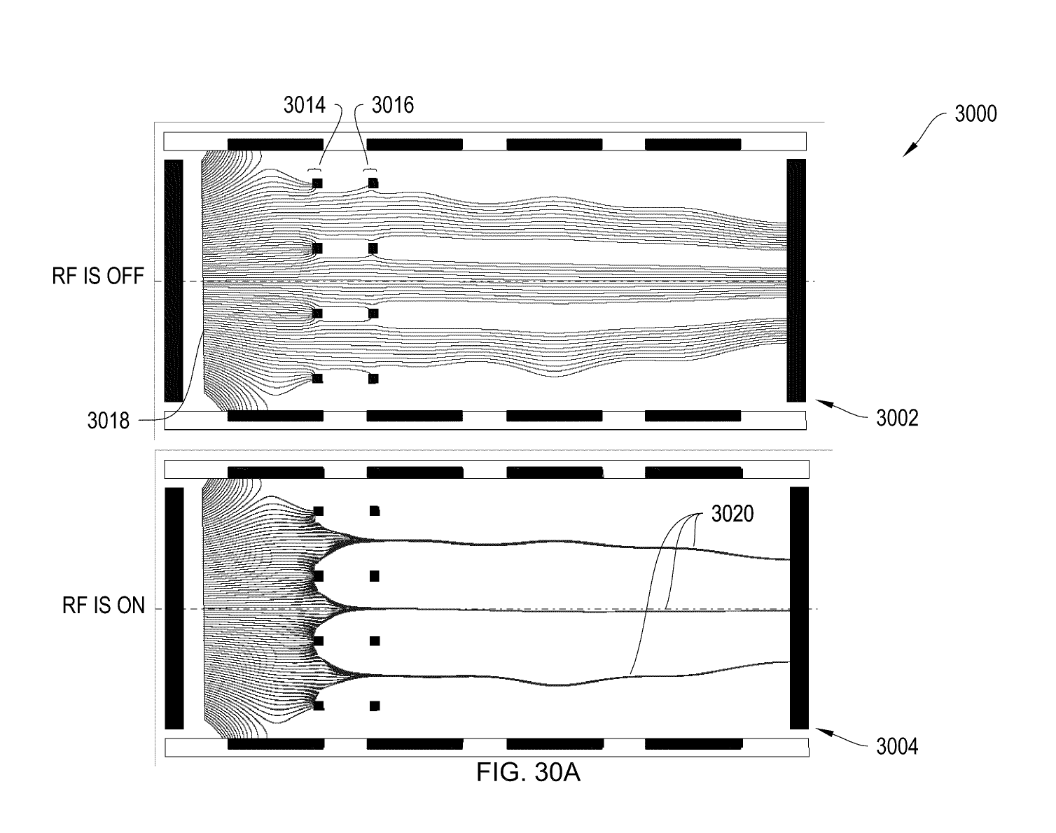

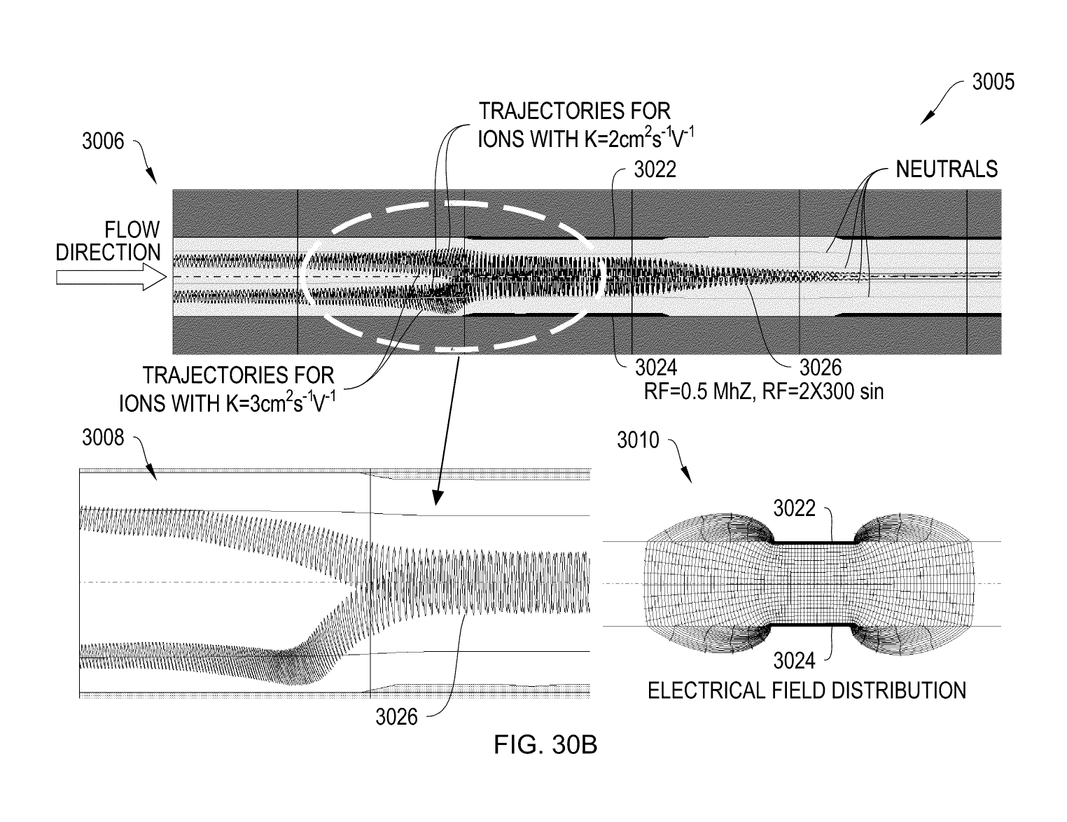

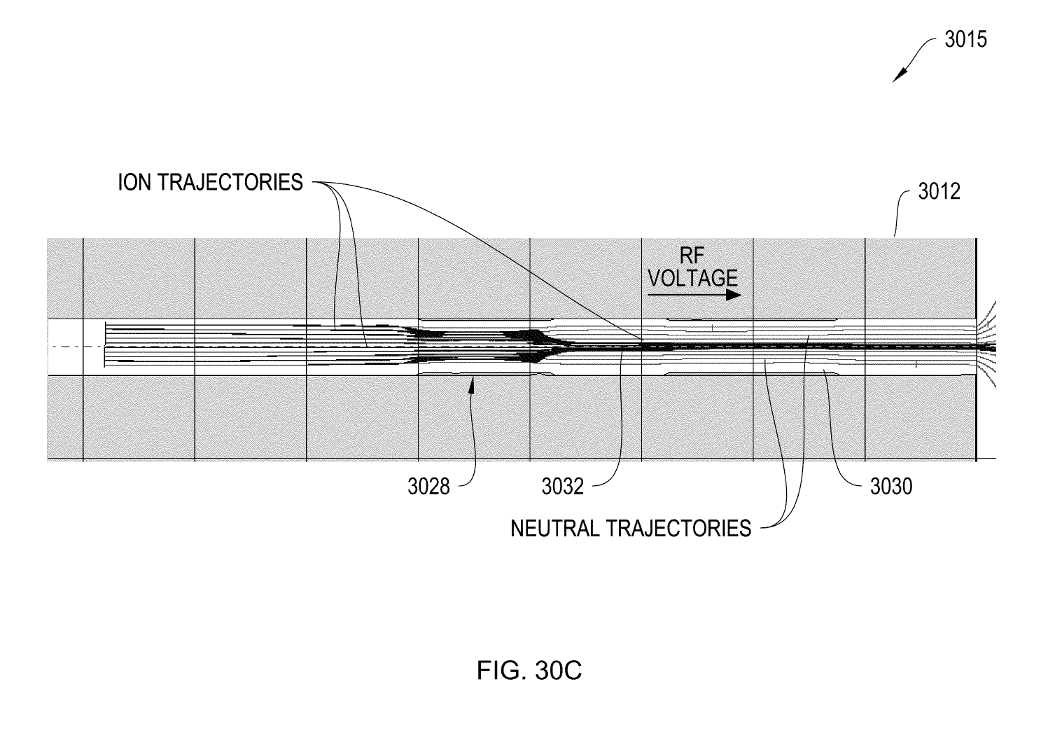

FIGS. 30A-30C show examples of an ion focusing assembly according to an illustrative embodiment of applicants' teachings. FIG. 30A shows ion focusing assembly 3000 having two grids 3014 and 3016. Grids 3014 and 3016 may operate in a similar fashion as grids 2004 and 2006 of FIG. 20. Grids 3014 and 3016 are located in a perpendicular direction to gas stream 3018. Plot 3002 shows ion focusing assembly 3000 when an RF voltage is not applied to grids 3014 and 3016. Plot 3004 shows ion focusing assembly 3000 when an RF voltage is applied to grids 3014 and 3016. In plot 3004, the ions are focused into focused ion streams 3020.

FIG. 30B shows an ion focusing assembly 3005 having electrodes 3022 and 3024. In certain embodiments ion focusing assembly 3005 may including one or more electrodes in addition to electrodes 3022 and 3024. In assembly 3005, as ion flow in the flow direction a harmonic RF voltage may be applied to electrodes 3022 and 3024 creating a voltage field that is perpendicular to the ion flow. As a result, the ions are focused into a focused ion stream 3026 in the direction of the flow rate. Plot 3008 shows the result of applying a harmonic RF voltage to focus the ions into focused ion stream 3026. Plot 3010 shows the electric field distribution between electrodes 3022 and 3024.

FIG. 30C shows an ion focusing assembly 3015 having electrode pair 3028 and electrode pair 3030. In ion focusing assembly 3015, an RF voltage is applied between electrode pair 3028 and electrode pair 3030 in the direction of ion flow resulting in a focused ion stream 3032 that is parallel to the RF voltage field.

In each of the ion focusing assembly examples above, focusing of the ions occur while the trajectory of neutrals remain unchanged. In certain embodiments, the ion focusing assembly may be located in front of or behind an ion mobility filter (e.g., a DMS filter). In the case that the ion focusing assembly is located before the ion mobility filter, the ion focusing occurs for all ion species. In the case that the ion focusing assembly is located after the ion mobility filter, ion focusing occurs only for selected (filtered) ion species. In certain embodiments one or more ion focusing channels may be used. For example, ions may be focused in one channel and transferred to another, or separate ion streams may be simultaneously focused in one or more channels.

Embodiments of applicants' teachings may be practiced in method and apparatus using cylindrical, planar and other configurations and still remain within the spirit and scope of applicants' teachings. Examples of applications for applicants' teachings include use in biological and chemical sensors, and the like. Various modifications of the specific embodiments set forth above are also within the spirit and scope of applicants' teachings. The examples disclosed herein are shown by way of illustration and not by way of limitation. The scope of these and other embodiments is limited only as set forth in the following claims.

While applicants' teachings have been particularly shown and described with references to preferred embodiments thereof, it will be understood by those skilled in the art that various changes in form and details may be made therein without departing from the scope of applicants' teachings encompassed by the appended claims.

What is claimed is:

1. A sample analysis system, comprising:
an ion inlet for receiving ions arranged in a plurality of ion streams;
an ion detector for detecting the ions; and
an ion focusing assembly for converging the plurality of ion streams from the ion inlet into at least one focused ion stream, and directing the at least one focused ion stream toward the ion detector.

2. The system of claim 1, further comprising at least one filter channel for focusing at least one ion stream and selectively allowing certain ion species to pass through to the ion detector.

3. The system of claim 1, further comprising an atmospheric pressure operated ion pre-filter.

4. The system of claim 3, wherein the ion pre-filter includes a mobility-based filter.

5. The system of claim 4, wherein the mobility-based filter can be selected from the group consisting of cylindrical FAIMS, planar DMS, IMS, and aspiration DMA.

6. The system of claim 1, wherein the ion focusing assembly comprises:
a first grid having at least one opening through which ions may flow;
a second grid having at least one opening through which ions may flow;
a first and second DC voltage source; and
a time varying voltage source.

7. The system of claim 1, wherein the ion focusing assembly comprises:
first and second electrodes for applying an electric field perpendicular to the ion stream.

8. The system of claim 1, wherein the ion focusing assembly comprises:
first and second pairs of electrodes for applying an electric field between the first pair of electrodes and the second pair of electrodes, wherein the electric field is parallel to the ion stream.

9. The system of claim 1, wherein the ion detector comprises an analytical instrument including an inlet orifice for ion introduction.

10. The system of claim 1, wherein the ion detector comprises a mass spectrometer including an inlet orifice.

11. The system of claim 10, wherein directing includes focusing the focused ion stream into a narrow ion stream along a longitudinal axis directly into the inlet orifice of the mass spectrometer.

12. The system of claim 11, wherein the orifice diameter is less than about one of 100 microns, 75 microns, 50 microns, 25 microns, 20 microns, 10 microns and 5 microns.

13. The system of claim 4, wherein directing includes focusing the focused ion stream into a narrow ion stream along a longitudinal axis directly into the inlet of the ion mobility based filter.

14. The system of claim 1, further comprising a low-power sucking pump optimized for enabling an appropriate flow rate for DMS operation, ion focusing and flow into the ion detector.

15. The system of claim 1, wherein the ion focusing assembly comprises a deflector electrode for deflecting ions at a right angle toward the ion detector, and for preventing analyte neutrals from being introduced into the ion detector.

16. A method for analyzing a sample, comprising:
receiving ions at an ion inlet;
passing the ions through an ion focusing assembly and converging the ions into at least one focused ion stream; and
passing the at least one focused ion stream to an ion detector.

17. The method of claim 15, further comprising passing the ions through an atmospheric pressure operated ion pre-filter.

18. The method of claim 16, wherein passing the ions through an ion focusing assembly comprises:
passing the ions through a first grid via at least one opening;
converging the ions, using the ion focusing assembly, into at least one focused ion stream;
passing the at least one focused ion stream through a second grid via at least one opening into at least one filter channel.

19. The method of claim 16, wherein passing the ions through an ion focusing assembly comprises:
passing the ions through an electric field perpendicular to a flow of the ions; and
converging the ions, using the ion focusing assembly, into at least one focused ion stream.

20. The method of claim 16, wherein passing the ions through an ion focusing assembly comprises:
passing the ions through an electric field parallel to a flow of the ions; and
converging the ions, using the ion focusing assembly, into at least one focused ion stream.

21. The method of claim 18, further comprising applying a DC bias voltage to at least one of the first and second grids.

22. The method of claim 21, wherein the DC bias voltage can be selected from the group consisting of a ground voltage, a reference voltage, a positive voltage and a negative voltage.

23. The method of claim 22, further comprising:
applying a difference in DC potentials across the first and second grids thereby generating an electric field between the first and second grids; and
converging the ions into at least one focused ion stream using the electric field between the first and second grids.

24. The method of claim 18, further comprising:
applying a time-varying voltage across the first and second grids; and
converging the ions into at least one focused ion stream using the time-varying voltage across the first and second grids.

25. A system for analyzing a sample, comprising:
means for receiving ions at an ion inlet;
means for passing the ions through an ion focusing assembly and converging the ions into at least one focused ion stream; and
means for passing the at least one focused ion stream to an ion detector.

26. The system of claim 25, further comprising means for passing the ions through an atmospheric pressure operated ion pre-filter.

27. The system of claim 25, wherein passing the ions through an ion focusing assembly comprises:
means for passing the ions through a first grid via at least one opening;
means for converging the ions, using the ion focusing assembly, into at least one focused ion stream;
means for passing the at least one focused ion stream through a second grid via at least one opening into at least one filter channel.

28. The system of claim 25, wherein passing the ions through an ion focusing assembly comprises:
means for passing the ions through an electric field perpendicular to a flow of the ions; and
means for converging the ions, using the ion focusing assembly, into at least one focused ion stream.

29. The system of claim 25, wherein passing the ions through an ion focusing assembly comprises:
means for passing the ions through an electric field parallel to a flow of the ions; and
means for converging the ions, using the ion focusing assembly, into at least one focused ion stream.

30. The system of claim 27, further comprising means for applying a DC bias voltage to at least one of the first and second grids.

31. The system of claim 30, wherein the DC bias voltage can be selected from the group consisting of a ground voltage, a reference voltage, a positive voltage and a negative voltage.

32. The system of claim 31, further comprising:
means for applying a difference in DC potentials across the first and second grids thereby generating an electric field between the first and second grids; and
means for converging the ions into at least one focused ion stream using the electric field between the first and second grids.

33. The system of claim 27, further comprising:
means for applying a time-varying voltage across the first and second grids; and
means for converging the ions into at least one focused ion stream using the time-varying voltage across the first and second grids.
